(19) United States
(12) Patent Application Publication
(10) Pub. No.: US 2017/0372286 A1
(43) Pub. Date: Dec. 28, 2017

(54) POS DEVICE, CONTROL METHOD, AND NON-TRANSITORY COMPUTER-READABLE STORAGE MEDIUM

(71) Applicant: FUJITSU LIMITED, Kawasaki-shi (JP)

(72) Inventor: Yuta Hiroi, Akashi (JP)

(73) Assignee: FUJITSU LIMITED, Kawasaki-shi (JP)

(21) Appl. No.: 15/624,366

(22) Filed: Jun. 15, 2017

(30) Foreign Application Priority Data
Jun. 23, 2016 (JP) 2016-125024

(51) Int. Cl. G06Q 20/20

(52) U.S. Cl. CPC G06Q 20/20

(57) ABSTRACT

A point of sales (POS) device includes: a movable part configured to be switchable between a first position in which the movable part faces in a first direction and a second position in which the movable part faces in a second direction; a sensor configured to detect an object in a detection range including the first direction; and a control circuit configured to determine whether the movable part is in the first position and if the movable part is in the first position, control notification to a store clerk in accordance with a detection signal from the sensor.

### CROSS-REFERENCE TO RELATED APPLICATION

This application is based upon and claims the benefit of priority of the prior Japanese Patent Application No. 2016-125024, filed on Jun. 23, 2016, the entire contents of which are incorporated herein by reference.

### FIELD

The embodiments discussed herein are related to a POS device, a control method, and a non-transitory computer-readable storage medium.

### BACKGROUND

In a related art, a point of sales (hereinafter referred to as POS) system is used to manage information at the point of sale in the distribution industry, the restaurant industry, and the like. Here, “POS” may be used as a wording that means a method in which various achievements in sale of products and provision of service are counted and managed as data. Since a common product code was established in various regions in the 1970s, the POS system has been widely used by retailers and the like. For example, Universal Product Code (UPC) was formulated in the United States in 1973, European Article Number (EAN) code was formulated in Europe in 1977, and Japanese Article Number (JAN) code was formulated in Japan in 1978.

High functionality of a terminal device having a POS system or a cash register into which a function of a POS terminal is incorporated (hereinafter collectively referred to as a POS device) has been progressing along with the progress of information technology. For example, there are attempts to provide a plurality of sensors in a POS device placed at a checkout location and perform control corresponding to the surrounding circumstance. More specifically, a first sensor that detects the presence of a nearby store clerk and a second sensor that detects the presence of a customer are provided in the POS device. The store clerk is notified of approach of the customer to the POS device on the condition that a customer is detected through the second sensor and a store clerk is not detected through the first sensor. Examples of the related art include Japanese Laid-open Patent Publication No. 06-251260 and Japanese Laid-open Patent Publication No. 2000-207637.

### SUMMARY

According to an aspect of the invention, a point of sales (POS) device includes: a movable part configured to be switchable between a first position in which the movable part faces in a first direction and a second position in which the movable part faces in a second direction; a sensor configured to detect an object in a detection range including the first direction; and a control circuit configured to determine whether the movable part is in the first position and if the movable part is in the first position, control notification to a store clerk in accordance with a detection signal from the sensor.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a configuration of a system including a POS device and a store clerk terminal;

FIG. 2 is a flowchart illustrating an example of a flow of processing executed by a control unit of the POS device;

FIG. 3 is a perspective view illustrating an example of a first position of a POS device according to a first embodiment;

FIG. 4 is a perspective view illustrating an example of a second position of the POS device according to the first embodiment;

FIG. 5 is a side view illustrating an example of the first position of the POS device according to the first embodiment;

FIG. 6 is a side view illustrating an example of the second position of the POS device according to the first embodiment;

FIGS. 7A and 7B are diagrams each illustrating an example of a positional relationship between a customer, a store clerk, and the POS device according to the first embodiment;

FIG. 8 is a diagram illustrating an example of a configuration of a system including a store clerk terminal and the POS device according to the first embodiment;

FIG. 9 is a flowchart illustrating an example of a flow of processing executed by a processor of the POS device according to the first embodiment;

FIG. 10 is a diagram illustrating an example of a screen A output to a first display unit of the POS device according to the first embodiment;

FIG. 11 is a diagram illustrating an example of a screen B output to the first display unit of the POS device according to the first embodiment;

FIG. 12 is a flowchart illustrating an example of a flow of processing executed by a processor of the store clerk terminal according to the first embodiment;

FIGS. 13A and 13B are perspective views respectively illustrating examples of a first position and a second position of a POS device according to a second embodiment;

FIG. 14 is a diagram illustrating an example of a configuration of the POS device according to the second embodiment;

FIG. 15 is a flowchart illustrating an example of a flow of processing executed by a processor of the POS device according to the second embodiment;

FIG. 16 is a diagram illustrating an example of a configuration of a system including a store clerk response tag and a POS device according to a third embodiment;

FIG. 17 is a flowchart illustrating an example of a flow of processing executed by a processor of the POS device according to the third embodiment;

FIG. 18 is a diagram illustrating an example of a configuration of a POS device according to a fourth embodiment;

FIGS. 19A and 19B are diagrams each illustrating an example of a positional relationship between a customer, a store clerk, and the POS device according to the fourth embodiment;

FIG. 20 is a perspective view illustrating an example of the appearance of a human sensor of the POS device according to the fourth embodiment; and

FIG. 21 is a flowchart illustrating an example of a flow of processing executed by a processor of the POS device according to the fourth embodiment.

### DESCRIPTION OF EMBODIMENTS

In the related art, notification to a store clerk is performed if the human sensor provided in the POS device detects a customer during the store clerk is absent from the POS device. On the other hand, notification to the store clerk is suppressed during the store clerk is near the POS device. As a result, notification to the store clerk who may already recognize the presence of the customer near the POS device may be avoided.

However, in the related art, a case is not considered in which the store clerk near the POS device leaves the POS device after having recognized the presence of the customer. For example, a case may occur in which the store clerk temporarily leaves the POS device during a checkout operation at the POS device in order to check the price of a product displayed on a display shelf. In the related art, the presence of a human is determined merely using a detection signal of the human sensor, so that it is technically difficult to determine whether the customer is already recognized by the store clerk or the customer is newly detected. Therefore, in one aspect of the related art, there is a technical problem in which the work efficiency of the store clerk is reduced because the store clerk who temporarily leaves the POS device during, for example, the checkout operation at the POS device is notified of unnecessary approach detection. In addition, in another aspect of the related art, there is a technical problem in which a customer may hold an unpleasant impression of being monitored because the store clerk is notified of unnecessary approach detection.

As one aspect of the present embodiment, provided are solutions for being able to further appropriately control, in the POS device, whether the store clerk is to be notified of approach of a customer to the POS device including a sensor.

Embodiments of a POS device, a program of the POS device, and a control method of the POS device of the technology discussed herein are described below in detail with reference to drawings. The technology discussed herein is not limited to such embodiments. In addition, the same symbol is assigned to configurations having the same function in the embodiments, and the duplicated description may be omitted herein.

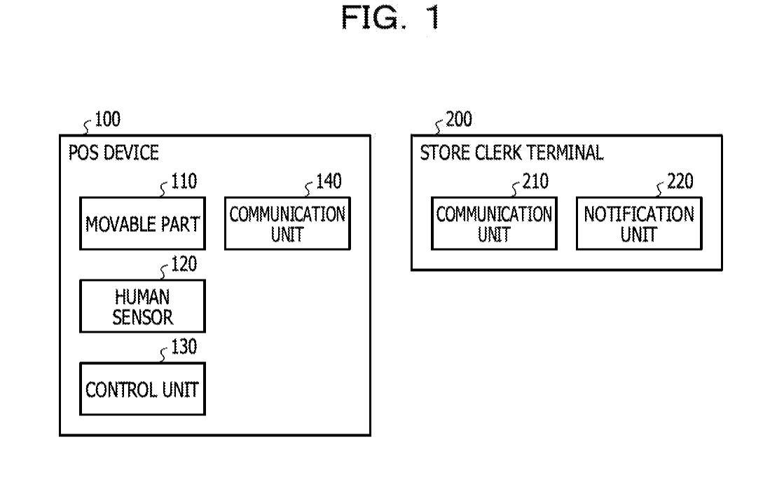

FIG. 1 is a diagram illustrating an example of a configuration of a system including a POS device 100 and a store clerk terminal 200. The POS device 100 of FIG. 1 includes a movable part 110, a human sensor 120, a control unit 130, and a communication unit 140.

The movable part 110 is configured to be switchable between a first position in which the movable part 110 faces in a first direction and a second position in which the movable part 110 faces in a second direction in the POS device 100. That is, the POS device 100 in the first position corresponds to a state in which the movable part 110 faces in the first direction. The POS device 100 in the second position corresponds to a state in which the movable part 110 faces in the second direction. For example, the movable part 110 is coupled to the body of the POS device 100 through a uniaxial hinge and may switch the first position and the second position so as to rotate around the uniaxial hinge within a specific range for the body of the POS device 100.

The human sensor 120 is a sensor configured to detect an object (human body) in a detection range including the first direction, and, for example, a ranging sensor for human body detection may be used for the human sensor 120. As such a ranging sensor, for example, an optical sensor for which the principle of triangulation is applied may be used. A typical optical ranging sensor includes an infrared light emitting diode (LED) that is a light emitting element and a position sensitive detector (PSD) that is a light receiving element. When the principle of ranging is outlined, light of the infrared LED is projected through a light emitting part lens, is reflected off an object (human body), and strikes one point on the light receiving element through the light emitting part lens. The light incidence position on the light receiving element changes depending on a distance up to the object (human body), so that output of a signal corresponding to the distance up to the object (human body) may be performed when the light incidence position on the light receiving element is detected. For example, the human sensor 120 may perform output of a signal indicating a larger value as the distance up to the object (human body) becomes smaller.

The control unit 130 is configured to execute processing in which detection of the presence of a customer is notified in accordance with a detection signal from the human sensor 120 when the movable part is in the first position. That is, the control unit 130 may disable a detection signal of the human sensor 120 when the movable part 110 is in the second position. The control unit 130 may reduce power consumption by deactivating the human sensor 120 if the movable part 110 is in the second position. The control unit 130 may deactivate the human sensor 120, for example, by stopping supply of an operation clock to the human sensor 120 if the movable part 110 is in the second position.

The communication unit 140 is configured to perform transmission of a notification signal used to notify a specific store clerk terminal 200 of detection of a customer when the control unit 130 detects the customer using a detection signal from the human sensor 120. The communication unit 140 may transmit and receive a radio signal to and from the store clerk terminal 200, for example, using wireless communication through a wireless local area network (LAN) or the like, or wired communication through an unshielded twisted pair (UTP) cable of a 10BASE-T (IEEE802.3i) standard or the like.

The store clerk terminal 200 of FIG. 1 includes a communication unit 210 and a notification unit 220. The communication unit 210 is configured to receive a notification signal transmitted from the communication unit 140 of the POS device 100 and supply the notification signal to the notification unit 220.

The notification unit 220 is configured to notify the store clerk of detection of a customer by the POS device 100, using the notification signal supplied from the communication unit 210. For the notification, vibration, sound, light, or a combination of vibration, sound, and light may be used. For example, the notification unit 220 drives a vibrator that causes vibration to occur by rotation of an eccentricity weight motor, and performs notification to the store clerk when the notification unit 220 receives the notification signal. Alternatively, the notification unit 220 may notify the store clerk of approach of the customer by performing output of sound corresponding to the notification signal through a speaker or an earphone.

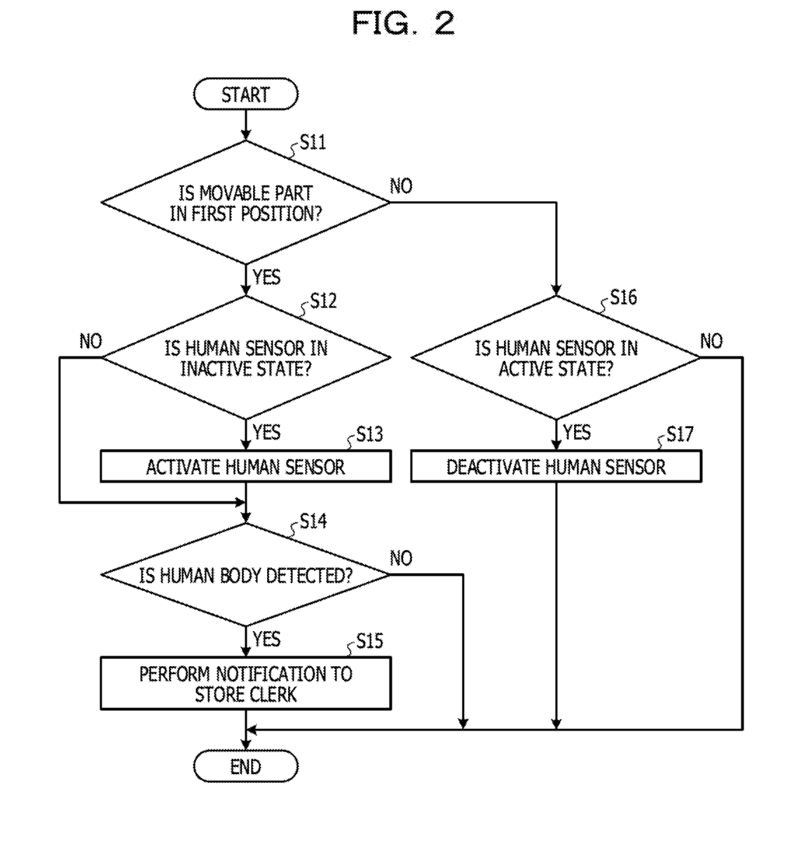

FIG. 2 is a flowchart illustrating an example of a flow of processing executed by the control unit 130 of the POS device 100. The flow of the processing illustrated in FIG. 2 is executed, for example, at specific cycles. The specific cycle may be, for example, a cycle repeated in a relatively-short time period such as one second or 10 milliseconds, or may be a cycle repeated at time intervals such as 10 seconds or 30 seconds.

When the processing illustrated in FIG. 2 starts, the control unit 130 determines whether the movable part 110 of the POS device 100 is in the first position in which the movable part 110 faces in the first direction (S11). For example, a sensor or a switch may be used through which the control unit 130 may recognize a first value (for example, high level) when the movable part 110 is in the first position and may recognize a second value (for example, low level) when the movable part 110 is the second position, in conjunction with the position of the movable part 110. The control unit 130 may determine whether the movable part 110 is in the first position by receiving a signal from such a sensor or the like and determining whether the value of the signal is the first value.

When the control unit 130 determines that the movable part 110 is in the first position (YES in S11), and the control unit 130 determines whether the human sensor 120 is in an inactive state (S12). For example, when the control unit 130 determines that the value of a register used for control of power supply to the human sensor 120 is a value indicating a state in which power supply to the human sensor 120 is blocked, with reference to the value of the register, the control unit 130 may determine that the human sensor 120 is in the inactive state. The value of the register used for control of power supply may be, for example, a value indicating whether a clock signal desired for an operation of the human sensor 120 is supplied to the human sensor 120.

When the control unit 130 determines that the human sensor 120 is in the inactive state (YES in S12), the control unit 130 activates the human sensor 120 (S13). For example, the control unit 130 may instruct a power source control circuit that controls power supply to the human sensor 120 in accordance with the value of the register used for control of power supply to the human sensor 120 to start power supply to the human sensor 120 by rewriting the value of the register to a value indicating that the human sensor 120 is in the active state. The processing of the power source control circuit that controls power supply to the human sensor 120 in accordance with the value of the register may be executed by the control unit 130. For example, the control unit 130 may cause the human sensor 120 to be in the active state by supplying a clock signal desired for the operation of the human sensor 120 to the human sensor 120.

The control unit 130 determines whether a human body is detected in the detection range including the first direction using a detection signal from the human sensor 120 (S14) in the state in which the human sensor 120 is activated (after execution of S13 or NO in S12). For example, it is assumed that the value of the detection signal from the human sensor 120 indicates a larger value as the distance up to the human body becomes shorter. The control unit 130 may compare the detection signal from the human sensor 120 with a specific threshold value Xth in the processing of S14, and determine that a human body is detected when the detection signal exceeds the specific threshold value Xth. Alternatively, the control unit 130 may determine that a human body is detected when the detection signals which exceed the specific threshold value Xth are continuously received the specific number of times after one or more detection signals supplied from the human sensor 120 are received within an interval shorter than an execution cycle of the processing illustrated in FIG. 2. The specific number of times may be obtained by setting, as appropriate, a value enough to avoid false detection of instantaneous approach of a customer such as a case in which a customer passes near to the POS device 100, with reference to a relationship between the detection range and the measurement cycle of the human sensor 120. For example, when a customer who walks in the store passes through the detection range of the human sensor 120 with the typical walking speed of a customer, a value that exceeds an average value of the number of times of detection within the measurement cycle of the human sensor 120 may be used. As a result, it may be avoided that the customer who merely passes near to the POS device 100 is detected as a customer who waits for checkout by mistake. In addition, in a case in which the number of continued detection signals each of which exceeds the specific threshold value Xth is counted, when a difference with the value of the previous detection signal exceeds a specific value, it is probable that a plurality of customers passes near to the POS device 100 one after another, so that the detection signal may be excluded from the count targets. Here, the specific value may be set at a value by which an abnormal value is allowed to be determined with reference to the typical walking speed (or stride length) of a customer and the measurement cycle.

When the control unit 130 determines that a human body is detected (YES in S14), the control unit 130 notifies the store clerk of the detection of the customer by transmitting a notification signal to a specific store clerk terminal 200 using the communication unit 140 (S15).

After the control unit 130 transmits a notification signal to the store clerk terminal 200 (after execution of S15), or when the control unit 130 determines that a condition of human body detection is not satisfied based on the current detection signal from the human sensor 120 (NO in S14), the processing ends. When the specific execution cycle arrives, the control unit 130 may execute the processing of S11 and the subsequent steps again.

In the above-described determination processing of S11, when the movable part 110 is not in the first position in which the movable part 110 faces in the first direction (NO in S11), the control unit 130 determines whether the human sensor 120 is in the active state (S16). For example, the control unit 130 may determine that the human sensor 120 is in the active state when the control unit 130 determines that the value of the register used for control of power supply to the human sensor 120 is a value indicating that power supply to the human sensor is being performed, with the value of the register. The value of the register used for control of power supply may be, for example, a value indicating whether a clock signal desired for the operation of the human sensor 120 is being supplied to the human sensor 120.

When the control unit 130 determines that the human sensor 120 is in the active state (YES in S16), the control unit 130 deactivates the human sensor 120 (S17). For example, the control unit 130 may instruct a power source control circuit that controls power supply to the human sensor 120 in accordance with the value of the register used for control of power supply to the human sensor 120 to block power supply to the human sensor 120 by rewriting the value of the register to a value indicating the state in which power supply is blocked (inactive state). The processing of the power source control circuit that controls power supply to the human sensor 120 in accordance with the value of the register may be executed by the control unit 130. For example, the control unit 130 may cause the human sensor 120 to be in the inactive state by blocking supply of a clock signal desired for the operation of the human sensor 120.

After the control unit 130 deactivates the human sensor 120 (after execution of S17), or when the control unit 130 determines that the human sensor 120 is not in the active state in the above-described determination of S16 (NO in S16), the control unit 130 ends the processing. When the specific execution cycle arrives, the control unit 130 may execute the processing of S11 and the subsequent steps again.

In the above-described processing, the store clerk may switch control of the POS device 100 depending on whether the movable part 110 of the POS device 100 is in the first position in which the movable part 110 faces in the first direction. For example, the control unit 130 of the POS device 100 is configured to control whether notification to the store clerk is performed using a detection signal of the human sensor 120 when the control unit 130 determines that the POS device 100 is in the first position. For example, the control unit 130 of the POS device 100 is configured to deactivate the control of whether notification to the store clerk is performed using a detection signal of the human sensor 120 when the control unit 130 determines that the POS device 100 is in the second position.

As described above, in the POS device 100 including a function that allows approach of a customer to be detected using the sensor, unnecessary notification may be avoided when the store clerk already recognizes the presence of a customer. For example, in a case in which the store clerk leaves the POS device 100 in a state in which the store clerk already recognizes the presence of a customer, when the movable part 110 of the POS device 100 is caused to be in the second position in which the movable part 110 faces in the second direction, notification processing to the store clerk using a detection signal from the human sensor 120 is not performed to avoid unnecessary notification. In addition, in a case in which the store clerk leaves the POS device 100 in a state in which a customer is not near the POS device 100, when the movable part 110 of the POS device 100 is caused to be in the first position in which the movable part 110 faces in the first direction, whether notification to the store clerk is performed using a detection signal from the human sensor 120 is controlled, so that the waiting time of a customer who is waiting to check out may be reduced. In addition, appropriate notification is achieved while unnecessary notification is avoided, so that an unpleasant impression that is to be held by a customer may be reduced.

### First Embodiment

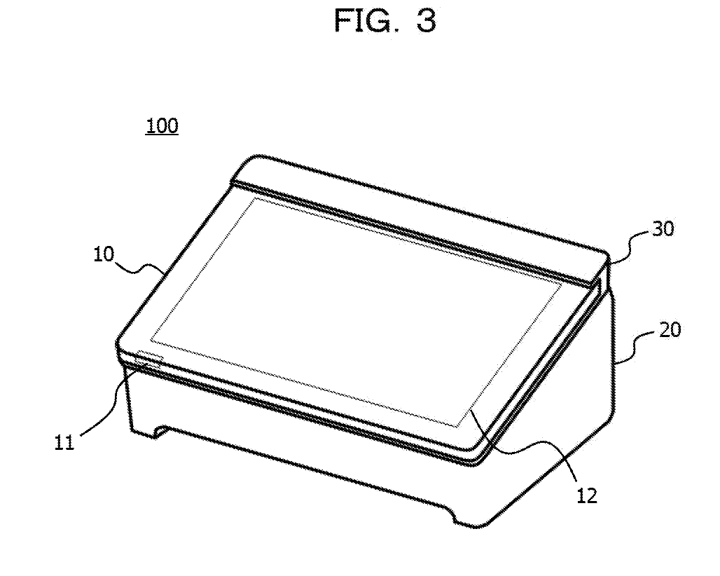

Embodiments by which the above-described disclosure is further embodied are described below in detail. First, a POS device 100 according to a first embodiment is described. FIG. 3 is a perspective view illustrating an example of a first position of a POS device 100 according to the first embodiment. In FIG. 3, the POS device 100 includes a first body unit 10, a second body unit 20, and a cradle unit 30.

In the POS device 100 according to the first embodiment, a movable part including the first body unit 10 and the cradle unit 30 is coupled to the second body unit 20 so as to be allowed to be rotated around an uniaxial hinge that is not illustrated. That is, in the first embodiment, the first body unit 10 and the cradle unit 30 correspond to an example of the movable part.

The first body unit 10 is, for example, a tablet-type information processing device (tablet-type computer), and is configured to be coupled to the cradle unit 30 so as to be allowed to be inserted into or removed from the cradle unit 30. In the perspective view illustrated in FIG. 3, as a part exposed in the first direction when the first body unit 10 coupled to the cradle unit 30 is in the first position, “human sensor 11” and “first display unit 12” are illustrated.

The human sensor 11 exposed in the first direction in the first position is configured to detect a human body in a detection range including the first direction. For example, when the POS device 100 is placed so that the first direction is roughly aligned with the assumed position of a customer, the customer may be included in the detection range of the human sensor 11 in the first position. In addition, in the embodiment, when the POS device 100 is placed so that the first direction is roughly aligned with the assumed position of the customer, the display surface of the first display unit 12 in the first position faces in the assumed direction of the customer. As a result, a display content of the first display unit 12 is controlled so as to be different depending on a detection signal of the human sensor 11, so that the customer may be made aware that the customer is detected by POS device 100. In addition, the display content of the first display unit 12 may be controlled so that information for customers such as advertisements is displayed on the first display unit 12 in the first position.

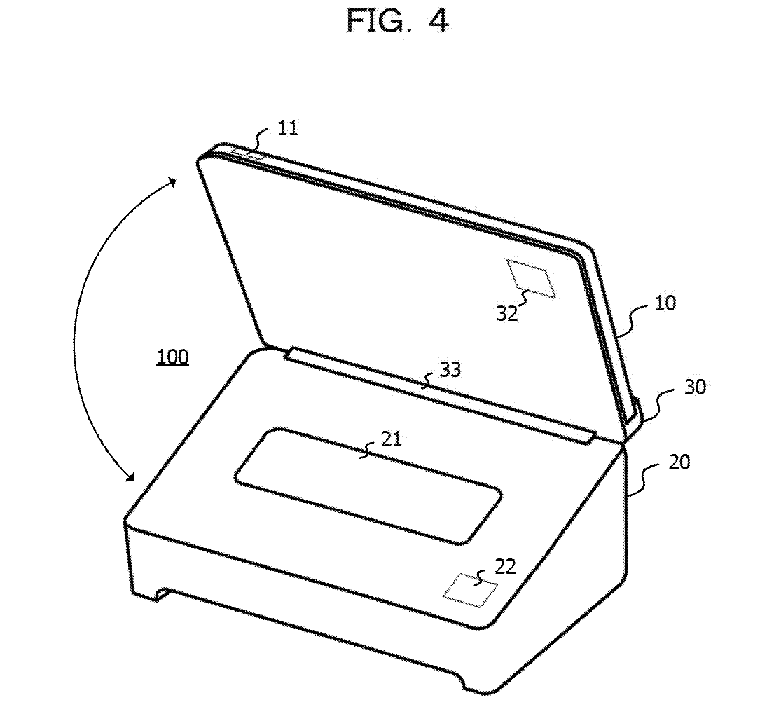

FIG. 4 is a perspective view illustrating an example of the second position of the POS device 100 according to the first embodiment. In FIG. 4, the first body unit 10 and the cradle unit 30 that correspond to the movable part of the POS device 100 face in a second direction when the first body unit 10 and the cradle unit 30 are rotated around a hinge unit 33 with respect to the second body unit 20. For example, when the POS device 100 is placed so that the second direction is roughly aligned with the assumed position of the store clerk, the first display unit 12 in the second position may be caused to face the store clerk, so that the store clerk may operate the POS device 100 smoothly.

In the POS device 100 in the second position, a second display unit 21 may be exposed in the first direction. As a result, while a display content for the store clerk located at the position within the range of the device's second direction may be displayed on the first display unit 12, a display content for the customer located at the position within the range of the device's first direction may be displayed on the second display unit 21. For example, the store clerk located at the position within the range of the device's second direction operates the POS device 100 in the second position with reference to the display content of the first display unit 12, and may execute settlement processing such as input of the price of a product that is to be purchased by the customer. In addition, the customer located at the position within the range of the device's first direction may know the price to be paid when control is performed so that the price of the product that is to be purchased by the customer is displayed on the second display unit 21.

In FIG. 4, a magnetic sensor 22 of the second body unit 20 and a magnet 32 of the cradle unit 30 are illustrated, but may not be exposed so as to be allowed to be visually checked from the appearance of the POS device 100 in the second position. The magnetic sensor 22 and the magnet 32 are examples of sensors that detect a configuration in which the first body unit 10 and the cradle unit 30 are that correspond to the movable part. For example, as the magnetic sensor 22, a magneto-resistance (MR) element may be used. The MR element is obtained by putting a phenomenon in which the electric resistance varies depending on the magnetic field to practical use, and for example, may detect the resistance value variation by the magnetic field, as a change in voltage. The magnetic sensor 22 outputs a detection signal indicating that the magnitude of the magnetic field from the magnet 32 is reduced when the magnetic sensor 22 and the magnet 32 are separated from each other in the second position. A magnetic sensor may be provided in the cradle unit 30, and a magnet may be provided in the second body unit 20. In addition, a hall element may be used as the magnetic sensor.

In the second position, the human sensor 11 exposed in the second direction does not detect a human body in the first direction. That is, in the second position, a detection range including the second direction by the human sensor 11 does not include the first direction. As a result, when the POS device 100 is placed so that the assumed position of the customer is roughly aligned with the first direction, it may be avoided that the human sensor 11 in the second position detects the customer located at the position within the range of the device's first direction.

As described above, for example, in a case in which the store clerk leaves the POS device 100 in the state in which the customer is not near the POS device 100, notification processing to the store clerk is executed in accordance with approach detection of a customer using a detection signal from the human sensor 11 that faces in the first direction when the POS device 100 is caused to be in the first position as illustrated in FIG. 3, so that the waiting time of the customer who is waiting to check out may be reduced. In addition, in a case in which the store clerk leaves the POS device 100 in the state in which the store clerk already recognizes the presence of the customer, when the POS device 100 is caused to be in the second position as illustrated in FIG. 4, the human sensor 11 that faces in the second direction does not detect the customer located at the position within the range of the device's the first direction, and notification of approach detection of the customer is not performed, so that unnecessary notification to the store clerk may be avoided. As described above, appropriate notification is achieved while the unnecessary notification is avoided, so an unpleasant impression that is to be held by a customer may be reduced.

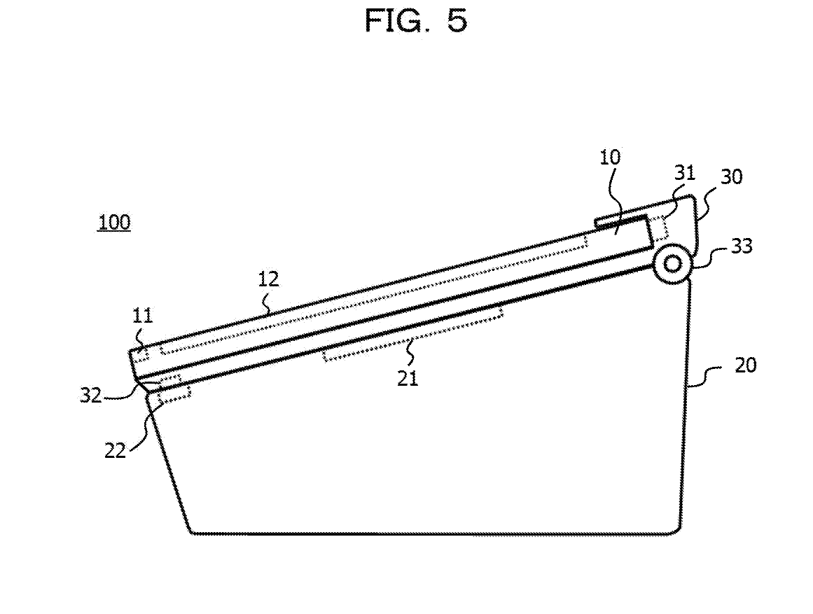

An example of a positional relationship of the configuration units of the POS device 100 according to the first embodiment from the side aspect is described below. FIG. 5 is a side view illustrating an example of the first position of the POS device 100 according to the first embodiment. In FIG. 5, at the left corner of the first body unit 10 of the POS device 100, the human sensor 11 is provided, and on the center part of the upper surface of the first body unit 10, the first display unit 12 is provided. The human sensor 11 and the first display unit 12 are not viewed from the side aspect, so that the human sensor 11 and the first display unit 12 are illustrated by the broken lines in FIG. 5. In the following description, a similar condition is applied to the other configurations units.

The second body unit 20 of the POS device 100 has a shape in which the height on the left side of FIG. 5 is lower than the height on the right side from the side aspect, and the upper surface is inclined to the left side. As a result, the first display unit 12 of the first body unit 10 in the first position leans to the left downwards in FIG. 5, and the visibility from the assumed position of the customer (that is, the position within the range of the device's first direction: the position on the left side of FIG. 5) is improved.

In FIG. 5, the second display unit 21 is provided on the center part of the upper surface of the second body unit 20, and the magnetic sensor 22 is provided at the position opposed to the magnet 32 of the cradle unit 30, which is located on the left side of the upper surface. As a result, when the POS device 100 is in the first position, the magnetic sensor 22 is most influenced by the magnetic field from the magnet 32 of the cradle unit 30. When the magnetic sensor 22 of the second body unit 20 measures the magnitude of the magnetic field received from the magnet 32 of the cradle unit 30, a processor of the POS device 100 may detect that the movable part including the first body unit 10 and the cradle unit 30 is in the first position based on the measurement result by the magnetic sensor 22. As a modification, for example, the magnetic sensor 22 may be configured to compare a threshold value set in advance with the measurement result, and supply, to the processor, a detection signal indicating a high level when the measurement result exceeds the threshold value and supply, to the processor, a detection signal indicating a low level when the measurement result is less than the threshold value. In the embodiment, it is not intended that a positional relationship on implementation between the magnetic sensor 22 and the magnet 32 is limited to the position illustrated in FIG. 5. For example, the magnetic sensor 22 and the magnet 32 may be provided near the hinge unit 33 located on the right side of FIG. 5.

The cradle unit 30 of the POS device 100 includes an interface unit 31 by which the first body unit 10 is coupled to the cradle unit 30 so as to be allowed to be inserted into or removed from the cradle unit 30, the magnet 32 provided so as to be opposed to the magnetic sensor 22 of the second body unit 20, and the hinge unit 33 provided at the right corner of the cradle unit 30 from the side aspect.

The hinge unit 33 is coupled to the second body unit 20 so as to be allowed to be rotated, and accommodates wiring formed on a flexible printed board that couples a circuit of the first body unit 10 coupled to the hinge unit 33 through the interface unit 31, to a circuit of the second body unit 20. In FIG. 5, for convenience of explanation, the hinge unit 33 is illustrated by the solid line, but the whole hinge unit may not be visually checked from the side aspect in practice.

In FIG. 5, the human sensor 11 located at the left corner of the first body unit 10 may detect a human body in the detection range including the first direction. The first direction is, for example, the left direction in FIG. 5.

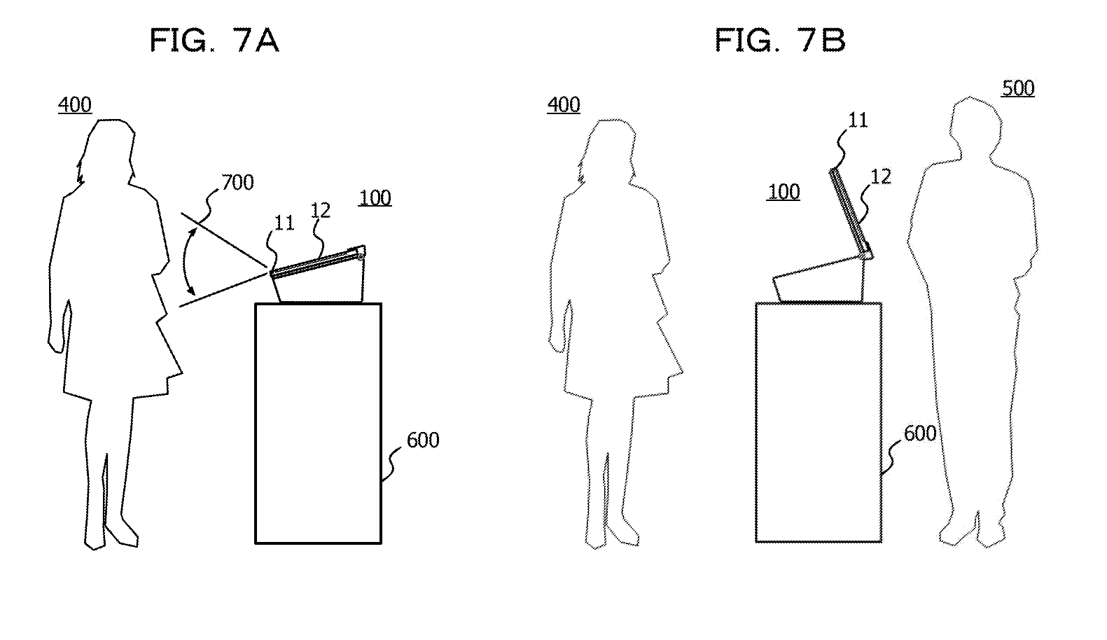

An example of a positional relationship between the detection range of the human sensor 11 in the first position and the customer is illustrated in FIG. 7A. In FIG. 7A, similar to FIG. 5, the first position of the POS device 100 from the side aspect illustrated. The POS device 100 is mounted on a stand 600, and a human body 400 (customer) may be detected in the detection range 700 including the first direction. As described above, when the POS device 100 is placed so that the assumed position of the customer is roughly aligned with the first direction, the first display unit 12 in the first position faces the customer, so that information for customers may be displayed on the first display unit 12. In addition, when the POS device 100 is placed so that the assumed position of the customer is included in the detection range 700, the human sensor 11 in the first position may detect approach of the customer 400. In FIG. 7A, the solid line indicating the detection range 700 illustrates an example of the width of the detection range, and it is not intended that the limitation of a distance in which the human sensor 11 detects a human body is indicated. A similar condition is applied to the other diagrams.

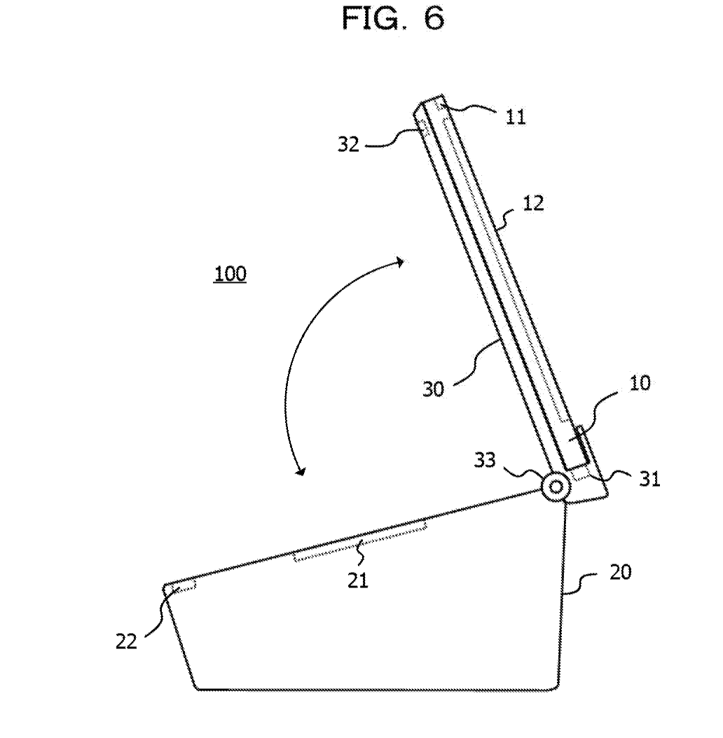

FIG. 6 is a side view illustrating an example of the second position of the POS device 100 according to the first embodiment. The form of the POS device 100 changes from the first position illustrated in FIG. 5 to the second position illustrated in FIG. 6 when the movable part including the first body unit 10 and the cradle unit 30 is rotated clockwise using the hinge unit 33 as the axis. When the POS device 100 is caused to become in the second position, the magnetic sensor 22 of the second body unit 20 and the magnet 32 of the cradle unit 30 are sufficiently separated from each other, so that the processor of the POS device 100 may detect that the movable part is in the second position because the magnetic field that the magnetic sensor 22 receives from the magnet 32 is reduced. As described above, as a modification, when the magnetic sensor 22 detects that a measurement result drops below the specific threshold value, and for example, supplies a detection signal indicating a low level to the processor of the POS device 100, the processor of the POS device 100 may be caused to detect that the movable part is in the second position. In the embodiment, it is not intended that a positional relationship on implementation between the magnetic sensor 22 and the magnet 32 is limited to the position illustrated in FIG. 6. For example, the magnetic sensor 22 and the magnet 32 may be provided on the side on which the hinge unit 33 of FIG. 6 is located.

In the second position, the first display unit 12 is configured to face in the second direction. Thus, when the POS device 100 is placed so that the second direction is roughly aligned with the position of the store clerk, the visibility of the first display unit 12 and the operability of the first body unit 10 may be improved for the store clerk. In addition, in the second position, when the first display unit 12 faces in the second direction, it may be avoided that the customer located at the position within the range of the device's first direction peeps the display content of the first display unit 12.

An example of a positional relationship between the POS device 100 in the second position, the customer 400, and a store clerk 500 is illustrated in FIG. 7B. In FIG. 7B, similar to FIG. 6, the second position of the POS device 100 from the side aspect is illustrated. The POS device 100 in the second position illustrated in FIG. 7B is mounted on the stand 600, and the first display unit 12 is configured to face in the second direction. As described above, when the store clerk 500 is located at the position within the range of the device's second direction that is a right direction from the stand 600 in FIG. 7B, the operability of the first body unit 10 and the visibility of the first display unit 12 for the store clerk 500 located at the position within the range of the device's second direction (on the right side of the stand 600) may be improved. In addition, when the first display unit 12 faces in the second direction, it may be avoided that the customer located at the position within the range of the device's first direction that is on the left side of FIG. 7B peeps the display content of the first display unit 12. In addition, the human sensor 11 of the first body unit 10 faces in a direction different from the first direction, so that detection of the customer 400 who is located at the position within the range of the device's first direction may be avoided even when the human sensor 11 of the second position is caused to be in the active state.

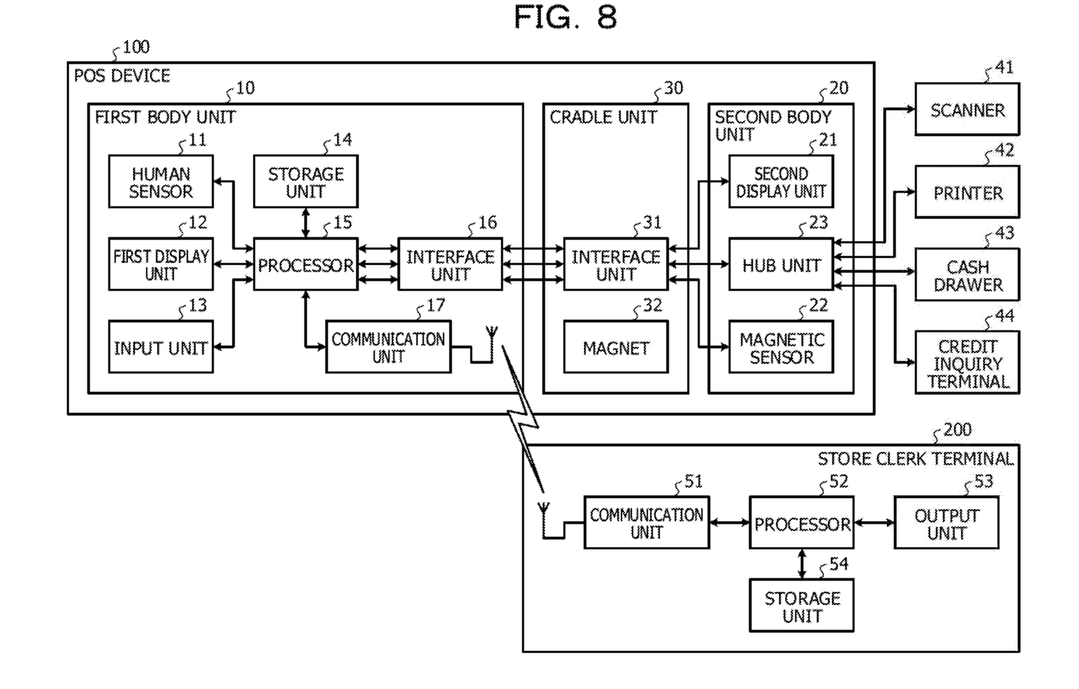

FIG. 8 is a diagram illustrating an example of configurations of the POS device 100 and the store clerk terminal 200 according to the first embodiment included in a system. The POS device 100 of FIG. 8 includes the first body unit 10, the second body unit 20, and the cradle unit 30. The first body unit 10 and the cradle unit 30 correspond to an example of the movable part.

The first body unit 10 includes a human sensor 11, a first display unit 12, an input unit 13, a storage unit 14, a processor 15, an interface unit 16, and a communication unit 17. The human sensor 11, the first display unit 12, the input unit 13, the storage unit 14, the interface unit 16, and the communication unit 17 are coupled to the processor 15 through buses or dedicated wiring of the first body unit 10.

The human sensor 11 corresponds to the human sensor 11 illustrated in FIGS. 3 to 7, and is configured to be allowed to detect a human body in the detection range including the first direction when the movable part is in the first position. The human sensor 11 may output, to the processor 15, a detection signal corresponding to the distance up to the human body in the detection range including the first direction by receiving power supply. For example, the human sensor 11 may be configured to output, to the processor 15, a signal indicating a larger value as the distance up to the human body becomes closer.

The first display unit 12 corresponds to the first display unit 12 illustrated in FIGS. 3 to 7, and is configured to display characters, symbols, and the like based on an instruction from the processor 15. For example, as the first display unit 12, there is a liquid crystal display (LCD), an organic electro luminescence (OEL) display, an organic light emitting diode (OLED) display, or the like.

The input unit 13 is configured to output, to the processor 15, an input signal corresponding to an input operation by a user (for example, a store clerk or a customer) by receiving the input to the first body unit 10 by the user. For example, as the input unit 13, there is a touch pad to which a position may be input so that a sensor on the flat plate is traced with the finger, a keyboard, a mouse, or the like. A touch panel obtained by combining the input unit 13 and the first display unit 12 may be used.

The storage unit 14 is configured to store a program, data, and the like by which the processing according to the first embodiment is defined. For example, as the storage unit 14, there is a random access memory (RAM), a read only memory (ROM), a solid state drive (SSD), a hard disk drive (HDD), or the like.

The processor 15 is configured to execute the processing according to the first embodiment by reading the program stored in the storage unit 14 and executing an instruction set described in the program. That is, a control circuit that executes the processing according to the first embodiment is configured by causing the processor 15 of the POS device 100 to execute the program according to the embodiment stored in the storage unit 14. The processor 15 is an example of a control unit. For example, as the processor 15, there is a central processing unit (CPU), a micro processing unit (MPU), a field-programmable gate array (FPGA), or the like. The processor 15 may be a multiprocessing unit on which a plurality of processor cores is mounted, or any of the processor cores mounted on the multiprocessing unit.

The interface unit 16 is configured to be coupled to the interface unit 31 of the cradle unit 30 so as to be allowed to be inserted into or removed from the interface unit 31, and couples a circuit of the second body unit 20 (for example, the second display unit 21, a hub unit 23, the magnetic sensor 22) to a circuit of the first body unit 10 (for example, the processor 15) through the interface unit 31. For example, as the interface unit 16, there is a connector compatible with a universal serial bus (USB) standard, a connector compatible with an inter-integrated circuit (I2C) standard, or a combination of the connectors.

The communication unit 17 is configured to be allowed to transmit and receive a signal to and from the store clerk terminal 200 by a wired line or wirelessly based on an instruction from the processor 15. For example, as communication unit 17, wireless communication such as Bluetooth (registered trademark) or a wireless local area network (WLAN), wired communication through a communication path such as an electrical wire or an optical fiber, a communication path obtained by combining such wireless communication and wired communication, or the like, may be used. In FIG. 8, an example is illustrated in which wireless communication is used between the POS device 100 and the store clerk terminal 200.

In addition, the second body unit 20 includes the second display unit 21, the magnetic sensor 22, and the hub unit 23. The second display unit 21, the magnetic sensor 22, and the hub unit 23 are coupled to the interface unit 31, for example, through wiring formed on a flexible printed board, and are coupled to the processor 15 through the interface unit 31 and the interface unit 16 due to the coupling of the interface unit 31 and the interface unit 16.

The second display unit 21 corresponds to the second display unit 21 illustrated in FIGS. 4 to 6, and is configured to output a display content for a customer based on an instruction from the processor 15. For example, as the second display unit 21, there is a customer display using a vacuum fluorescent display, an LED, an OEL, a liquid crystal element, or the like.

The magnetic sensor 22 corresponds to the magnetic sensor 22 illustrated in FIGS. 4 to 6, and is configured to supply a detection signal obtained by measuring the magnetic field received from the magnet 32 of the cradle unit 30, to the processor 15 through the interface unit 31 and the interface unit 16. For example, as the magnetic sensor 22, there is a sensor using an MR element, a hall element, or the like.

The hub unit 23 is configured as an external interface that couples, to the second body unit, peripheral equipment such as a scanner 41, a printer 42, a cash drawer 43, a credit inquiry terminal 44, and the like. For example, as the hub unit 23, there is a USB hub controller.

The scanner 41 is configured to read information on a common product code or the like from a barcode attached to a price tag of a product, a radio frequency identifier (RFID) tag, or the like, and supply the read information to the POS device 100 (for example, the processor 15). The printer 42 is configured to print information on a receipt or the like on a thermal paper or the like, based on an instruction from the processor 15. The cash drawer 43 is configured to store cash such as banknotes and coins and is configured so that a cash storage is opened and closed, in conjunction with the processor 15 or independently of the processor 15. The credit inquiry terminal 44 is configured to inquire about information on a credit card to a center that conducts credit inquiry to execute settlement processing, in conjunction with the processor 15 or independently of the processor 15. These pieces of peripheral equipment 41 to 44 may be configured to receive power supply through connection paths with the hub unit 23.

The cradle unit 30 illustrated in FIG. 8 includes an interface unit 31 and a magnet 32. The interface unit 31 corresponds to the interface unit 31 illustrated in FIGS. 5 and 6, and is configured to couple the interface unit 16 of the first body unit 10 to the cradle unit 30 so that the interface unit 16 is allowed to be inserted into or removed from the cradle unit 30. For example, as the cradle unit 30, there is a connector compatible with a USB standard, a connector compatible with an I2C standard, or a combination of such connectors.

In addition, the interface unit 31 is configured to be coupled to the second display unit 21, the magnetic sensor 22, and the hub unit 23 of the second body unit 20 through the wiring formed on the flexible printed board. The wiring of the flexible printed board that couples the interface unit 31 to the circuit of the second body unit 20 are accommodated in the hinge unit 33 that is not illustrated in FIG. 8.

The magnet 32 is configured to apply specific magnetic field to the magnetic sensor 22 of the second body unit 20 in the first position. The magnet 32 of the cradle unit 30 may be provided in the second body unit 20, and the magnetic sensor 22 of the second body unit 20 may be provided in the cradle unit 30. In that case, the magnetic sensor provided in the cradle unit 30 is configured to supply a detection signal to the processor 15 through the interface unit 31 and the interface unit 16. As described above, the POS device 100 according to the embodiment includes such a configuration example.

The store clerk terminal 200 illustrated in FIG. 8 is described below. The store clerk terminal 200 includes a communication unit 51, a processor 52, an output unit 53, and a storage unit 54. The communication unit 51, the output unit 53, and the storage unit 54 are coupled to the processor 52 through buses or dedicated wiring of the store clerk terminal 200.

The communication unit 51 is configured to be allowed to transmit and receive a signal to and from the communication unit 17 of the first body unit 10 using wired communication or wireless communication. For example, as the communication unit 51, wireless communication such as Bluetooth or a WLAN, wired communication through a communication path such as an electrical wire or an optical fiber, or a communication path obtained by combining such wireless communication and wired communication may be used. When the communication unit 51 receives a notification signal indicating that approach of a customer is detected using the human sensor 11 in the first position, from the communication unit 17 of the first body unit 10, the communication unit 51 supplies the notification signal to the processor 52 of the store clerk terminal 200.

The processor 52 is configured to execute the processing according to the first embodiment by reading a program stored in the storage unit 54 and executing an instruction set described in the program. That is, when the program according to the first embodiment stored in the storage unit 54 is caused to executed by the processor 52, a control circuit that executes the processing of the store clerk terminal 200 according to the first embodiment is configured. For example, as the processor 52, there is a CPU, an MPU, an FPGA, or the like. The processor 52 may be a multiprocessing unit on which a plurality of processor cores is mounted, or any one of the processor cores mounted on the multiprocessing unit. The processor 52 performs notification to the store clerk using the output unit 53 when the processor 52 receives a notification signal from the POS device 100 through the communication unit 51 by executing the program according to the first embodiment.

The output unit 53 is configured to perform notification to the store clerk using vibration, sound, light, or a combination of vibration, sound, and light, under the control of the processor 52. For example, as the output unit 53, there is a speaker that outputs sound with a specific volume, an eccentricity weight motor that outputs vibration, an LED that outputs light, or the like.

The storage unit 54 is configured to be allowed to store a program that defines processing of the store clerk terminal according to the first embodiment, data used for the processing, and the like. For example, as the storage unit 54, there is a RAM, a ROM, an SSD, an HDD, or the like.

As described above, the store clerk terminal 200 according to the first embodiment includes such a configuration. Although not illustrated in FIG. 8, similar to the first body unit 10, the store clerk terminal 200 may include a display unit and an input unit. In addition, the store clerk terminal 200 according to the embodiment may be configured so that a generic smartphone is caused to execute a program for the store clerk terminal according to the embodiment. Alternatively, a wireless earphone compatible with a wireless communication standard of Bluetooth or the like may be used as the store clerk terminal 200.

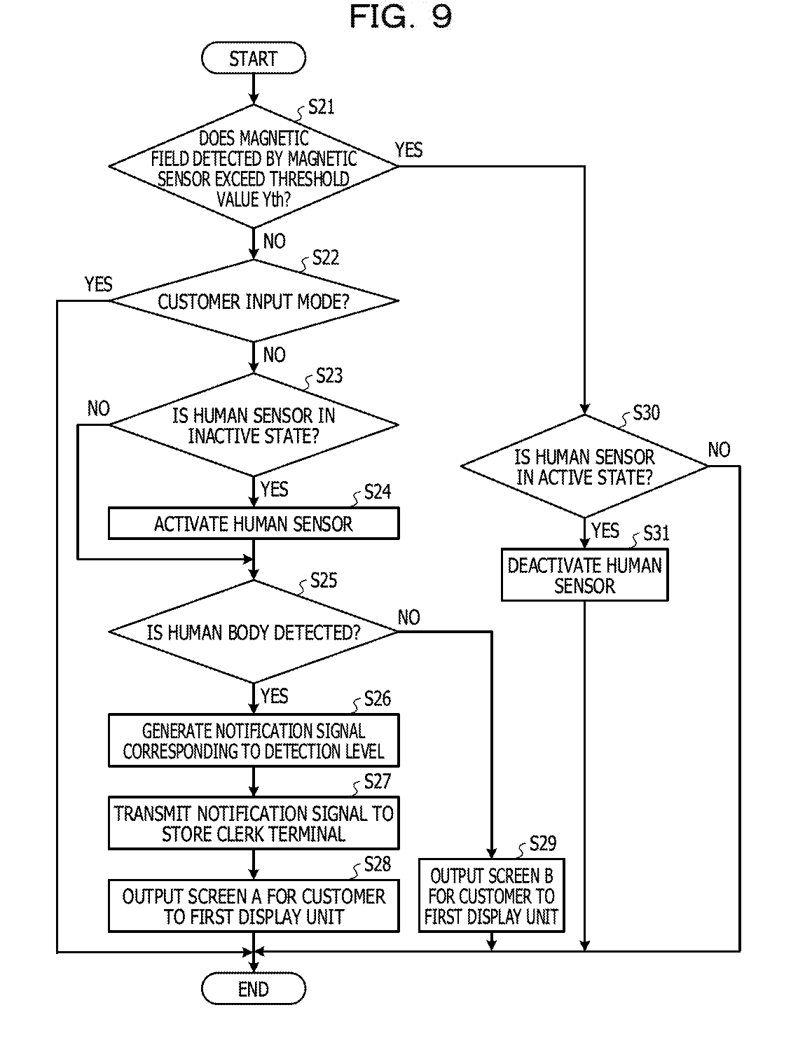

FIG. 9 is a flowchart illustrating an example of a flow of the processing executed by the processor 15 of the first body unit 10 of the POS device 100 according to the first embodiment. The flow of the processing illustrated in FIG. 9 is executed, for example, at specific cycles. The specific cycle may be, for example, a cycle repeated in a relatively-short time period such as one second or 10 milliseconds, or may be a cycle repeated at time intervals such as 10 seconds or 30 seconds.

When the processing illustrated in FIG. 9 starts, the processor 15 determines whether the magnetic field detected by the magnetic sensor exceeds a threshold value Yth stored in the storage unit 14 by referring to a value indicated by a detection signal from the magnetic sensor 22 coupled to the processor 15 through the interface unit 16 and the interface unit 31 and comparing the specific threshold value Yth with the value of the detection signal (S21). For example, when the first body unit 10 and the cradle unit 30 that configures the movable part is in the first position, the detection signal from the magnetic sensor 22 becomes a value indicating that the magnetic sensor 22 is strongly influenced by the magnetic field from the magnet 32. For the specific threshold value Yth, a value enough to determine that the magnetic sensor 22 is strongly influenced by the magnetic field from the magnet 32 in the first position may be set and stored in the storage unit 14. When the processor 15 determines that the value of the detection signal from the magnetic sensor exceeds the threshold value Yth, it is detected that the POS device 100 is in the first position. In the embodiment, it is not intended that a method that detects whether the POS device according to the first embodiment is in the first position is limited to the magnetic sensor 22. For example, a sensor or switch may be used through which the processor 15 may recognize a first value (for example, high level) when the movable part is in the first position, and recognize a second value (for example, low level) when the movable part is in the second position, in conjunction with the position of the movable part including the first body unit 10 and the cradle unit 30. The processor 15 may determine whether the movable part of the POS device 100 is in the first position by determining whether the value of a signal from such a sensor or the like is the first value when having received the signal from the sensor or the like.

When the value of the detection signal from the magnetic sensor 22 exceeds the threshold value Yth (YES in S21), the processor 15 determines whether the current operation state is a customer input mode (S22). The customer input mode is a state in which processing is executed in which the customer is caused to input information by processing of a further program executed in the processor 15. For example, in settlement processing using a credit card, for example, the customer input mode is used to cause the customer to input the signature to a signature column displayed on the first display unit 12. For example, when the processing of the further program related to the customer input mode is executed, a value indicating that the current operation state is the customer input mode may be stored in the storage unit 14, as a value indicating the current operation state (operation state value). The processor 15 may determine whether the current operation state is the customer input mode with reference to the operation state value stored in the storage unit 14.

It is assumed that the store clerk serves the customer near the POS device when the current operation state is the customer input mode, so that approach detection of a customer through the human sensor becomes unnecessary even in the first position. Therefore, when the processor 15 determines that the current operation state is the customer input mode (YES in S22), the processor 15 ends the processing according to the first embodiment. When the specific execution cycle arrives, the processor 15 may execute the processing of S21 and the subsequent steps again.

When the processor 15 determines that the current operation state is not the customer input mode (NO in S22), the processor 15 determines whether the human sensor 11 is in the inactive state (S23). For example, when the processor 15 determines that the value of a register used for control of power supply to the human sensor 11 is a value indicating that power supply to the human sensor is not being performed, with reference to the value of the register, the processor 15 may determine that the human sensor 11 is in the inactive state. The value of the register used for control of power supply may be, for example, a value indicating whether a clock signal desired for the operation of the human sensor 11 is supplied to the human sensor 11.

When the processor 15 determines that the human sensor 11 is in the inactive state (YES in S23), the processor 15 activates the human sensor 11 (S24). For example, the processor 15 may instruct a power source control circuit that controls power supply to the human sensor 11 in accordance with the value of the register used for control of power supply to the human sensor 11 to start power supply to the human sensor 11 by rewriting the value of the register to a value indicating that the human sensor 11 is in the active state. The processor 15 may cause the human sensor 11 to be in the active state by supplying a clock signal desired for the operation of the human sensor 11 to the human sensor 11.

In the state in which the human sensor 11 is activated (after execution of S24 or NO in S23), the processor 15 determines whether a human body is detected in the detection range including the first direction using a detection signal from the human sensor 11 (S25). For example, the value of the detection signal from the human sensor 11 becomes larger as the distance up to the human body becomes closer. When the processor 15 compares the detection signal from the human sensor 11 with the specific threshold value Xth, and the detection signal exceeds the specific threshold value Xth, the processor 15 may determine that the human body is detected. Alternatively, in a measurement cycle having a time interval shorter than the execution cycle of the processing according to the embodiment illustrated in FIG. 9, when one or more detection signals are received from the human sensor, and the detection signals which exceed the specific threshold value Xth are continuously received the specific number of times, the processor 15 may determine that a human body is detected. For the specific number of times, a value enough to avoid false detection of instantaneous approach of a customer such as a case in which a customer passes near to the POS device 100 may be set as appropriate with reference to a relationship between the measurement cycle and the detection range of the human sensor 11. For example, when the customer who walks in the store passes through the detection range of the human sensor 11 at the typical speed of the customer, a value that exceeds an average value of times of detection within the measurement cycle of the human sensor 11 may be used. As a result, it may be avoided that a customer who merely passes near to the POS device 100 is detected as a customer who is waiting to check out by mistake. In addition, in a case in which the number of continued detection signals each of which exceeds the specific threshold value Xth is counted, when a difference with a value of the previous detection signal exceeds a specific value, it is probable that a plurality of customers passes one after another, so that the detection signal may be excluded from the count target. Here, as the specific value, a value may be set by which an abnormal value is determined with reference to the typical speed at which the customer walks (or stride length) and the measurement cycle.

When the processor 15 determines that a human body is detected (YES in S25), the processor 15 generates a notification signal corresponding to the detection level (S26), and transmits the notification signal to the store clerk terminal 200 (S27). The detection level is a value indicating an approach degree of a human body to the POS device 100. For example, the detection signal from the human sensor 11 indicates a larger value as the distance between the human sensor 11 to the human body becomes shorter, and is an example of a detection level indicating an approach degree of the human body.

The notification signal corresponding to the detection level may include, for example, a value indicating a detection level. As a result, when a notification method executed by the store clerk terminal 200 is caused to be different depending on a detection level, the store clerk who receives a notification may determine an approach degree of a customer. For example, a case of a notification signal having a low detection level may indicate that the distance between the human sensor 11 and the human body is not so short. In this case, it is highly probable that false detection occurs, so that the store clerk may ignore the initial notification. On the other hand, a case of a notification signal having a high detection level may indicate that the distance between the human sensor 11 and the human body is very short. In this case, a probability in which false detection occurs is low, so that the store clerk may recognize that the approach of the customer is to be responded as soon as possible.

In the embodiment, wording such as “generation of a notification signal” may include an example of selection of a notification signal corresponding to a detection level in accordance with a measurement result by the human sensor 11 from among notification signals stored in the storage unit 14 in advance for each type of assumed detection levels. For example, a music file having a different melody depending on a detection level is stored in the storage unit 14 in advance, and a music file of a melody corresponding to a detection level may be reproduced on the store clerk terminal 200 to perform notification to the store clerk when the music file corresponding to the detection level in accordance with a measurement result by the human sensor 11 is selected and transmitted to the store clerk terminal 200.

Before or after the processor 15 transmits a notification signal to the store clerk terminal 200, the processor 15 outputs a screen A for a customer to the first display unit 12 (S28). That is, the processing of S26 to S28 is not limited to the processing order illustrated in FIG. 9, and the processing order may be changed as appropriate within the scope of the spirit of the embodiments. A similar condition is applied to the other pieces of processing.

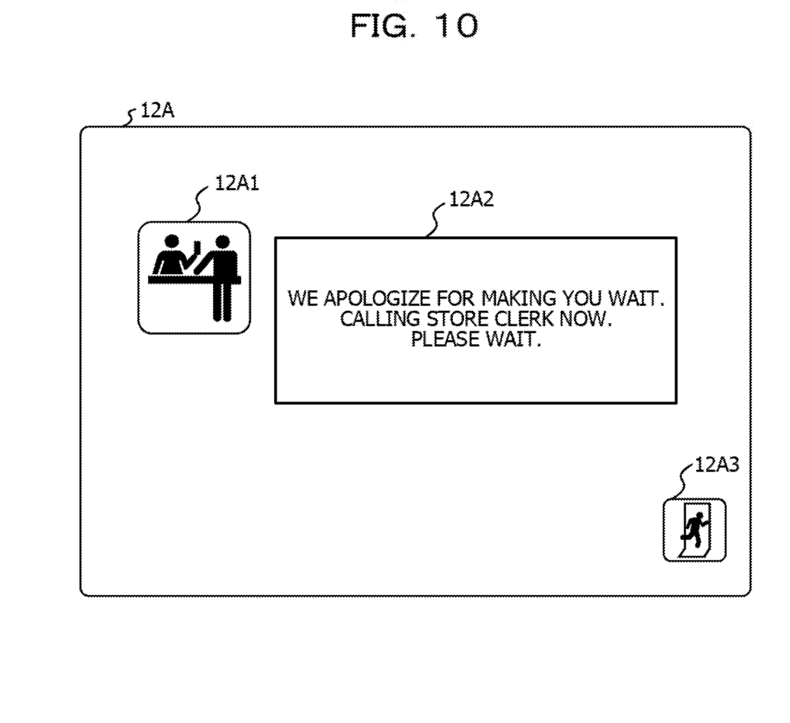

FIG. 10 is a diagram illustrating a content example of the screen A for a customer according to the first embodiment. On the screen A (12A) illustrated in FIG. 10, an icon 12A1 indicating that a notification for a customer, a message 12A2 indicating that the store clerk is being called, and an icon 12A3 that accept a pressing operation of the user when the user desires to close the screen A and display another screen such as a screen B are displayed. When the screen A illustrated in FIG. 10 is displayed on the first display unit 12, the customer may recognize that the store clerk comes after a while.

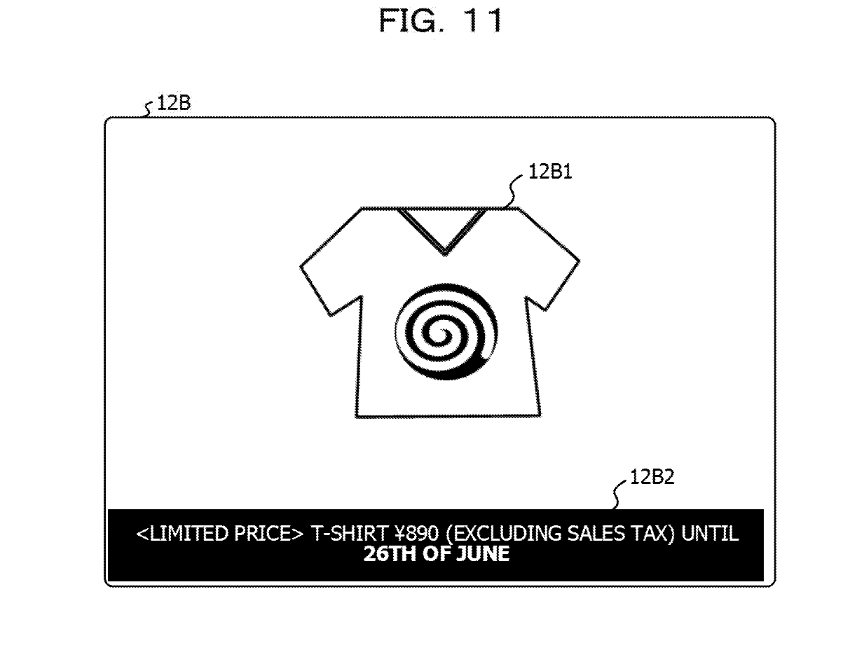

Processing when the POS device 100 is in the second position is described below. In the above-described processing of S25, when the processor 15 determines that a human body is not detected (NO in S25), the processor 15 outputs the screen B for a customer, to the first display unit 12 (S29). FIG. 11 is a diagram illustrating a content example of the screen B for a customer according to the embodiment. On the screen B (12B) illustrated in FIG. 11, as advertisement related to a product of a store in which the POS device is located, an image 12B1 of the product and advertisement information 12B2 indicating the price of the product and the like are displayed. When the screen B illustrated in FIG. 11 is displayed on the first display unit 12, the customer in the store notices a product for a limited time, which is displayed on the first display unit 12 of the POS device 100, and may be motivated to purchase the product. As the screen B for a customer, which is displayed in the processing of S29, a video that conveys a corporate image, a video that depicts music performance of a musician, or a video that conveys public interest information such as an election vote date may be reproduced, instead of individual product advertisement. Alternatively, in the processing of S29, when the first display unit 12 is caused to be in the inactive state instead of display of the screen B for a customer, the power consumption may be reduced.

After the execution of the processing of S28 or S29, the processor 15 may end the processing according to the first embodiment. In addition, when the specific execution cycle arrives, the processor 15 may execute the processing of S21 and the subsequent steps again.

When the processor 15 determines that the magnetic field detected by the magnetic sensor does not exceed the threshold value Yth in the above-described determination processing of S21 (NO in S21), the processor 15 determines whether the human sensor 11 is in the active state (S30). For example, the processor 15 may determine that the human sensor 11 is in the active state when the processor 15 determines that the value of the register used for control of power supply to the human sensor 11 is a value indicating that power supply to the human sensor is being performed, with reference to the value of the register. The processor 15 may determine whether the human sensor 11 is in the active state by determining whether a clock signal desired for the operation of the human sensor 11 is supplied to the human sensor 11.

When the processor 15 determines that the human sensor 11 is in the active state (YES in S30), the processor 15 deactivates the human sensor (S31). For example, the processor 15 may instruct a power source control circuit that controls power supply to the human sensor 11 in accordance with the value of the register used for control of power supply to the human sensor 11 to block power supply to the human sensor 11 by rewriting the value of the register to a value indicating a state in which power supply is blocked (inactive state). The processing of the power source control circuit that controls power supply to the human sensor 11 in accordance with the value of the register may be executed by the processor 15. For example, the processor 15 may cause the human sensor 11 to be in the inactive state by blocking supply of a clock signal desired for the operation of the human sensor 11.

After the processor 15 deactivates the human sensor 11 (after execution of S31) or when the processor 15 determines that the human sensor 11 is not in the active state in the above-described processing of S30 (NO in S30), the processor 15 may end the processing according to the first embodiment. When the specific execution cycle arrives, the processor 15 may execute the processing of S21 and the subsequent steps again. As described above, the processing of the POS device 100 according to the first embodiment include such a flow.

As a modification of the flow of the processing illustrated in FIG. 9, the following description is made. First, when the processor 15 determines that a human body is detected in the processing of S25 (YES in S25), the processor 15 may display a screen C used to ask a customer for confirmation of whether the customer desires to call a store clerk, on the first display unit 12. On the screen C (not illustrated), a message used to ask whether the customer desire to call a store clerk, a button that accepts an answer indicating that the customer desires to call a store clerk through an operation from the customer, and a button that accepts an answer indicating that the customer does not desire to call a store clerk are displayed.

In the state in which the screen C is displayed, when the processor 15 repeats determination of human body detection through a detection signal from the human sensor 11 at specific cycles and determines that the human body is not detected any more, the processor 15 may delete the display of the screen C and end the processing according to the first embodiment without execution of the processing of S26 to S28. In this case, before the processor 15 ends the processing according to the first embodiment, the processor 15 may perform control so as to execute the processing of S29 and display the screen B on the first display unit 12. When the specific execution cycle arrives, the processor 15 may execute the processing of S21 and the subsequent steps again.

When the processor 15 detects an operation of the button that accepts an answer indicating that the customer desires to call a store clerk through the screen C, the processor 15 may perform control so as to execute the processing of S26 to S28. When the processor 15 detects an operation of the button that accepts an answer indicating that the customer does not desire to call a store clerk through the screen C, the processor 15 may execute the processing of S29 without execution of the processing of S26 to S28. However, when approach detection of a customer is continued for a specific time period or more even in this case, the store clerk may be notified of approach of a customer so that the processing of S26 to S28 is executed, from the viewpoint of measures for crime prevention or the like.

Alternatively, when the processor 15 detects the operation of the button that accepts an answer indicating that the customer does not desire to call a store clerk through the screen C, the processor 15 may display the screen B such as advertisement for a customer by executing not the processing of S28 but the processing of S29 while notifying the store clerk of approach of the customer by executing the processing of S26 and S27, from the viewpoint of measures for crime prevention or the like. In this case, the processor 15 may differentiate output from the output unit 53 of the store clerk terminal 200 by differentiating a content to be notified through a notification signal depending on whether the customer performs an operation to desire to call a store clerk. As a result, the store clerk who receives a notification indicating that the customer already performs an operation not to desire to call the store clerk may recognize that the store clerk is to ignore the notification or that the store clerk is to go to the vicinity of the POS device from the viewpoint of measures for crime prevention.

As described above, when the processor 15 may perform further desirable appropriate notification control so that the store clerk is called as appropriate after the desire of the customer is confirmed instead of calling of the store clerk all the time when the processor 15 detects approach of the customer through the human sensor 1.

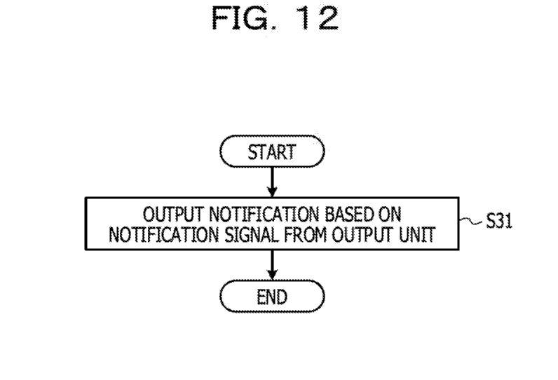

The store clerk terminal 200 according to the first embodiment is described below. FIG. 12 is a flowchart illustrating an example of a flow of the processing executed by the processor 52 of the store clerk terminal 200 according to the first embodiment. The flow of the processing illustrated in FIG. 12 is executed, for example, when the processor 52 receives supply of a notification signal through the communication unit 51 that has received the notification signal from the POS device 100.

When the processing illustrated in FIG. 12 starts, that is, when the processor 52 receives the notification signal from the POS device 100 through the communication unit 51, the processor 52 outputs a notification based on the notification signal through the output unit 53 (S31). For example, the processor 52 notifies the store clerk of reception of the notification signal indicating approach detection of a customer from the POS device 100 by driving an eccentricity weight motor (vibrator) as the output unit 53.

In the processing of S31, when the notification signal includes a detection level, the store clerk terminal 200 may drive the vibrator with the intensity and the rhythm corresponding to the detection level of the notification signal. As a result, as the detection level becomes larger, that is, as a distance between the human sensor 11 and the customer becomes shorter, the vibration intensity of the vibrator as the output unit 53 may be increased, or the vibrator may be rang with a specific rhythm indicating that the detection level is large. The store clerk who receives the notification may determine an approach degree of the customer depending on the vibration intensity and the rhythm of the output unit 53 of the store clerk terminal 200. For example, when the vibration intensity is weak, it is indicated that the distance between the human sensor 11 and the human body is not small so much, and it is probable that false detection occurs, so that the store clerk may ignore the initial notification. On the other hand, when the vibration intensity is strong, it is indicated that the distance between the human sensor 11 and the human body is very short, and a probability is low in which false detection occurs, so that the store clerk may recognize that the approach detection of the customer is to be responded to as soon as possible. Alternatively, when a speaker or an earphone is used as the output unit 53, a melody based on a notification signal may be reproduced in the processing of S31. Even in this case, the store clerk may determine an approach degree of the customer by the melody output from the output unit 53. As described above, the processing executed by the processor 52 of the store clerk terminal 200 according to the first embodiment includes such a flow.

### Second Embodiment

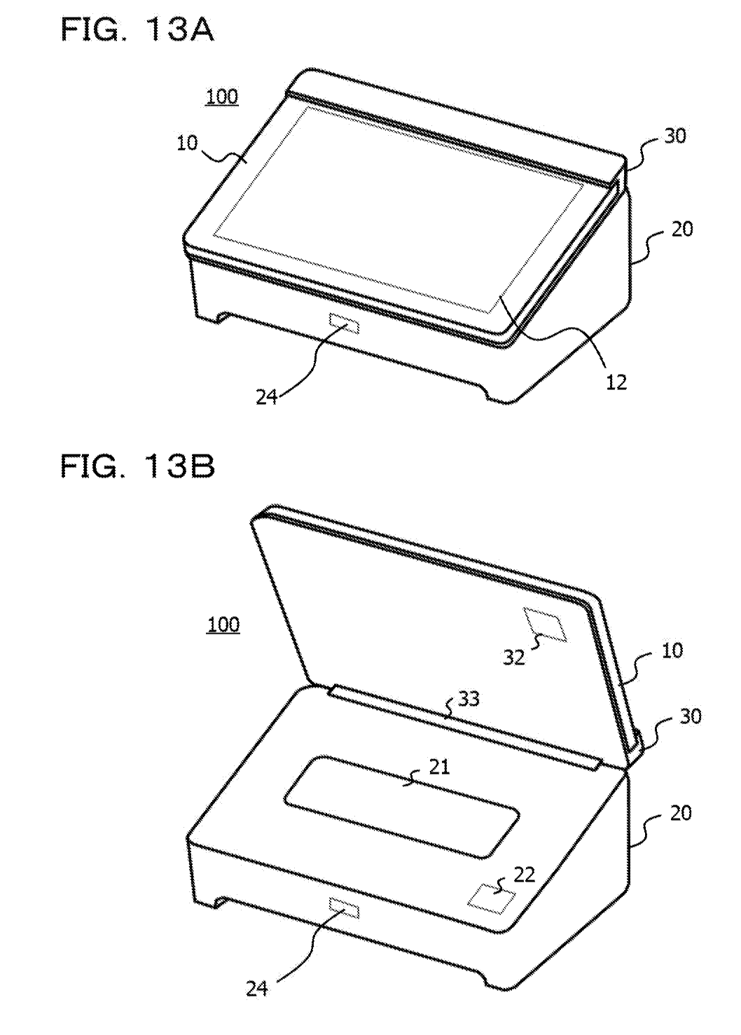

A POS device according to a second embodiment 100 is described below. FIGS. 13A and 13B are perspective views illustrating examples of the POS device 100 according to the second embodiment. FIG. 13A illustrates a first position of the POS device 100 according to the second embodiment, and FIG. 13B illustrates a second position of the POS device 100 according to the second embodiment. A difference with the first embodiment illustrated in FIGS. 3 and 4 is that a human sensor 24 is provided in a second body unit 20 of the POS device 100 illustrated in FIGS. 13A and 13B. A human sensor 11 may be provided or may not be provided in a first body unit 10. In FIGS. 13A and 13B, an example is described in which the human sensor 11 is not provided in the first body unit 10. The other configurations are similar to the configurations illustrated in FIGS. 3 and 4, so that the description is omitted herein.

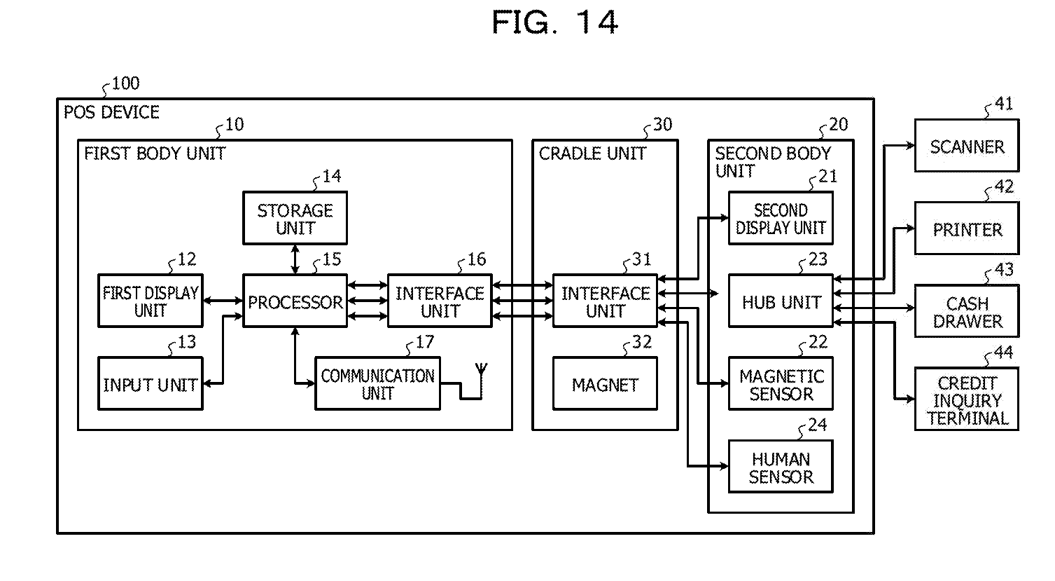

FIG. 14 is a diagram illustrating an example of a configuration of the POS device 100 according to the second embodiment. A store clerk terminal 200 may use a configuration similar to that of the first embodiment, so that the description is omitted herein. The POS device 100 illustrated in FIG. 14 is different from the POS device 100 according to the first embodiment illustrated in FIG. 8 in that the second body unit 20 includes a human sensor 24. As described above, the human sensor 11 of the first body unit 10 may be omitted or provided. The other configurations are similar to the configurations illustrated in FIG. 8, so that the description is omitted herein.

The human sensor 24 of the second body unit 20 is configured to detect a human body in a detection range including the first direction. The human sensor 24 is coupled to a processor 15 through an interface unit 31 and an interface unit 16, and supply a detection signal to the processor 15.

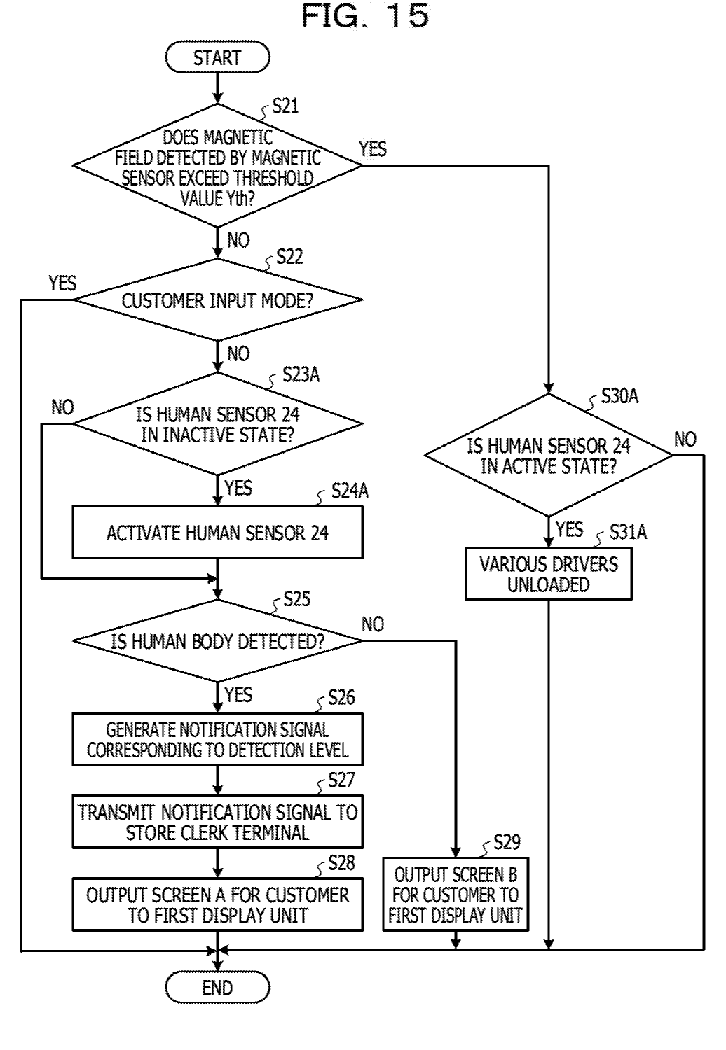

FIG. 15 is a flowchart illustrating an example of a flow of the processing executed by the processor 15 of the first body unit 10 of the POS device 100 according to the second embodiment. The flow of the processing illustrated in FIG. 15 is different from the flowchart according to the first embodiment illustrated in FIG. 9 in that a detection signal used for control performed by the processor 15 is supplied from the human sensor 24 of the second body unit 20. The other pieces of processing are similar to the pieces of processing illustrated in FIG. 9, so that the description is omitted herein. For example, when the processor 15 determines that the current operation state is not in the customer input mode in the processing of S22 illustrated in FIG. 15 (NO in S22), the processor 15 determines whether the human sensor 24 of the second body unit 20 is in the inactive state (S23A). When the processor 15 determines that the human sensor 24 is in the inactive state (YES in S23A), the processor 15 performs control so that the human sensor 24 of the second body unit 20 is caused to be in the active state (S24A). The specific content is similar to that of the first embodiment, so that the description is omitted herein. In addition, the processor 15 determines whether a human body is detected in the detection range including the first direction (S25), using a detection signal from the human sensor 24 of the second body unit 20, in the state in which the human sensor 24 of the second body unit 20 is activated (after the execution of S24A or NO in S23A). The processing of S25 and the subsequent steps is similar to the processing of the POS device 100 according to the first embodiment illustrated in FIG. 9, so that the description is omitted herein.

Processing when the POS device 100 according to the second embodiment is in the second position is described above. For example, when the processor 15 determines that the magnetic field detected by a magnetic sensor does not exceed a threshold value Yth in the processing of S21 illustrated in FIG. 15 (NO in S21), the processor 15 determines whether the human sensor 24 of the second body unit 20 is in the active state (S30A). When the processor 15 determines that the human sensor 24 is in the active state (YES in 530A), the processor 15 performs control so that the human sensor 24 of the second body unit 20 is caused to be in the inactive state (S31A). The specific content is similar to that of the first embodiment, so that the description is omitted herein. As described above, the processing executed by the processor 15 of the POS device 100 according to the second embodiment includes such a flow.

### Third Embodiment

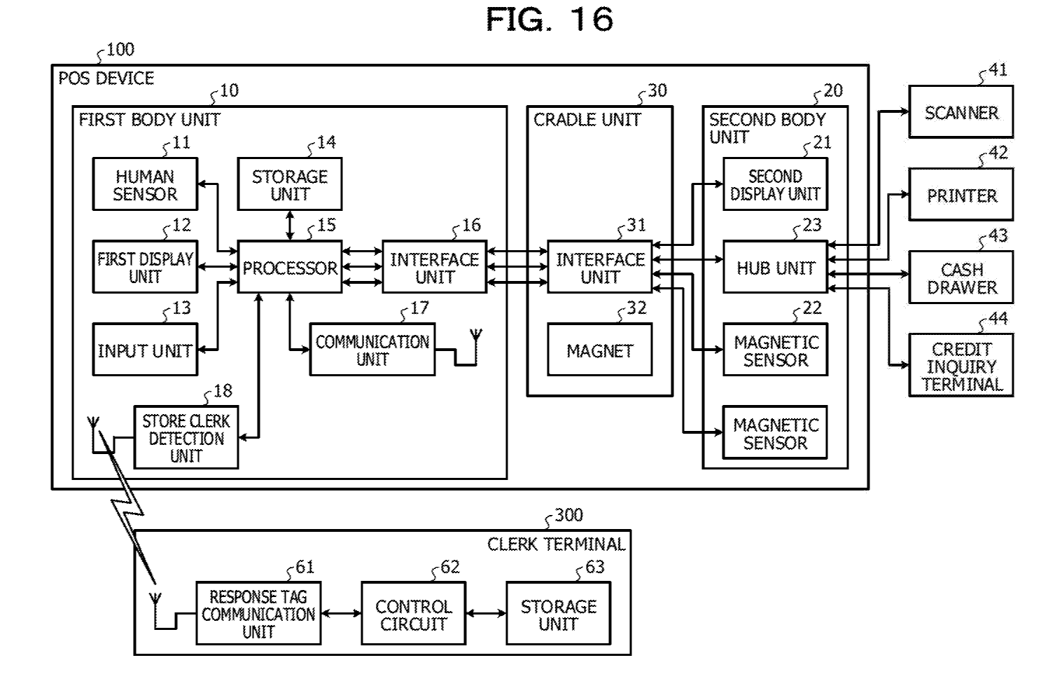

A POS device 100 according to a third embodiment is described below. FIG. 16 is a diagram illustrating an example of a configuration of a system including the POS device 100 and a store clerk response tag 300 according to the third embodiment. For a store clerk terminal 200, a configuration similar to the first embodiment may be used, so that the description is omitted herein.

The POS device 100 illustrated in FIG. 16 is different from the POS device 100 according to the first embodiment illustrated in FIG. 8 and the POS device 100 according to the second embodiment illustrated in FIG. 14 in that a first body unit 10 includes a store clerk detection unit 18. In addition, the configuration illustrated in FIG. 16 is different from those of the first embodiment illustrated in FIG. 8 and the second embodiment illustrated in FIG. 14 in that the system includes the store clerk response tag 300 allowed to perform short-range wireless communication with a store clerk detection unit 18 of the POS device 100. Here, in the short-range wireless communication performed between the store clerk detection unit 18 and the store clerk response tag 300, a range in which the communication is allowed to be performed is limited to a short distance as compared with the wireless communication performed between a communication unit 17 of the POS device 100 and a communication unit 51 of the store clerk terminal 200. For example, as the short-range wireless communication technology, there is a non-contact wireless communication technology such as ISO/IEC18092 (Near Field Communication) that is an international standard of near field wireless communication compatible with low power wireless communication at a distance of about ten centimeters or ISO/IEC14443 (MIFARE), or Felica (registered trademark). The example is described above in which the second body unit 20 includes the human sensor 24 in the POS device 100 illustrated in FIG. 16, but similar to the POS device 100 according to the first embodiment illustrated in FIG. 8, the first body unit 10 may include a human sensor 11. In this case, the human sensor 24 of the second body unit 20 may be omitted.

The store clerk detection unit 18 is configured to transmit an inquiry signal to the store clerk response tag 300, for example, at specific cycles through the short-range wireless communication, receive a response signal from the store clerk response tag 300 that already receives the inquiry, and supply the response signal to the processor 15. As a result, when the processor 15 does not receive a response signal from the store clerk response tag 300 within a specific time period range, the processor 15 may determine that the store clerk who possesses the store clerk response tag 300 is not near the POS device 100. Alternatively, when the processor 15 receives a response signal from the store clerk response tag 300 within the specific time period range, the processor 15 may determine that the store clerk who possesses the store clerk response tag 300 is near the POS device 100. In FIG. 16, the store clerk detection unit 18 is provided in the first body unit 10, but may be provided in the second body unit 20 or the cradle unit 30 when cooperation with the processor 15 is allowed to be performed. The store clerk detection unit 18 is an example of a second sensor that detects the presence of a store clerk.

The store clerk response tag 300 includes a response tag communication unit 61, a control circuit 62, and a storage unit 63. The store clerk response tag 300 may be an active tag that operates using a battery, or a passive tag that operates using radio waves radiated from an antenna of the store clerk detection unit 18 of the POS device 100 as an energy source.

The response tag communication unit 61 of the store clerk response tag 300 is configured to receive an inquiry signal from the POS device 100 and supply the inquiry signal to the control circuit 62. In addition, the response tag communication unit 61 is configured to transmit a response signal to the POS device 100, which is supplied from the control circuit 62 through the antenna.

The control circuit 62 is configured to receive an inquiry signal from the POS device 100 through the response tag communication unit 61 and transmit a response signal generated using identification information stored in the storage unit 63 to the POS device 100 through the response tag communication unit 61.

The storage unit 63 is a storage element such as a ROM or a RAM, and is configured to store identification information by which a store clerk is identified. When the store clerk response tag 300 is the passive tag, a ROM may be used as the storage unit 63 that stores identification information, from the viewpoint of a nonvolatile property. The identification information stored in the storage unit 63 may be a value by which each store clerk may be uniquely identified, or the same identification information may be shared between a plurality of store clerks.

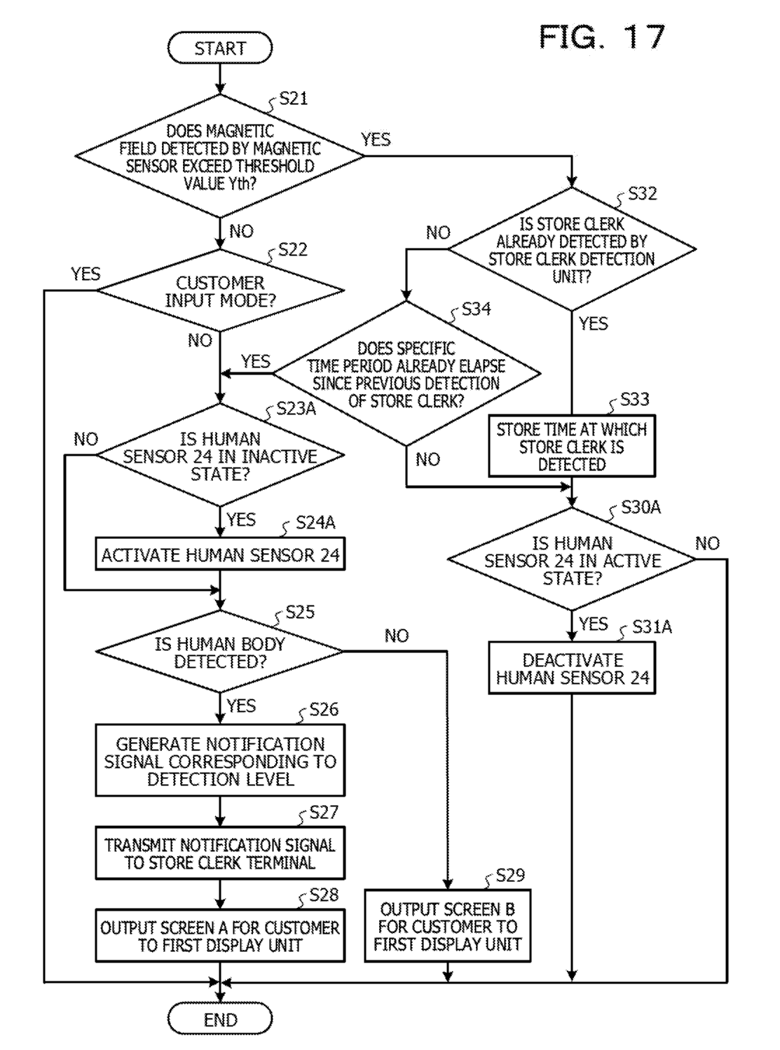

FIG. 17 is a flowchart illustrating an example of a flow of the processing executed by the processor 15 of the first body unit 10 of the POS device 100 according to the third embodiment. The flow of the processing illustrated in FIG. 17 is different from that of the second embodiment illustrated in FIG. 15 in that processing of S32 to S34 is added to the flow of the processing illustrated in FIG. 17 as processing executed by the processor 15 when the processor 15 determines that the magnetic field detected by a magnetic sensor does not exceed a threshold value Yth in the processing of S21 (NO in S21). The other pieces of processing are similar to those of the second embodiment illustrated in FIG. 15, so that the detailed description is omitted herein.

First, when “NO” is determined in the processing of S21 (that is, when the second position is detected), the processor 15 determines whether a store clerk is allowed to be detected in the store clerk detection unit 18 (S32). For example, the processor 15 may determine the presence or absence of detection of a store clerk by transmitting an inquiry signal to the store clerk response tag 300 through the store clerk detection unit 18 and determining whether a response signal from the store clerk response tag 300 is allowed to be received through the store clerk detection unit 18.

When the processor 15 determines that the store clerk is already detected (YES in S32), the processor 15 refers to the current time and stores the current time in the storage unit 14 as a time at which the store clerk is detected (S33). In addition, the processor 15 executes the processing of S30A and the subsequent steps. The processing of S30A and the subsequent steps is similar to that of the second embodiment, so that the description is omitted herein.

In addition, when the processor 15 determines that the store clerk is not allowed to be detected in the processing of S32 (NO in S32), the processor 15 determines whether a specific time period already elapses since the previous detection of the store clerk with reference to the time stored in the processing of S33 (the previous detection time) and the current time (S34). For example, the processor 15 may perform the determination in the processing of S34 by comparing the elapsed time obtained by subtracting the previous detection time from the current time with a specific threshold value. For example, when the elapsed time indicates a value that exceeds the specific threshold value as a result of the comparison, the processor 15 may determine that the specific time period already elapses since the previous detection of the store clerk.

When the processor 15 determines that the specific time period does not elapse since the previous detection of the store clerk (NO in S34), the processor 15 executes the processing of S30A and the subsequent steps illustrated in FIG. 17. The processing of S30A and the subsequent steps is similar to that of the second embodiment, so that the description is omitted herein.

When the processor 15 determines that the specific time period already elapses since the previous detection of the store clerk (YES in S34), the processor 15 executes the processing of 23A illustrated in FIG. 17 and the subsequent steps (however, except for the processing in S28 and S29). As a result, even in a case in which the POS device 100 is in the second position, when the state in which the store clerk is absent from the POS device 100 is continued so as to exceed the specific time period, the processor 15 may perform control so as to detect approach of a customer through the human sensor. For example, when it is assumed that the store clerk temporarily leaves the POS device 100 during a checkout operation in the POS device 100 in order to check the price of a product that is to be purchased by the customer, the upper limit value of a time typically expected until the store clerk checks the price of the product and returns to the POS device 100 again may be set at a threshold value referred to in the determination of the processing of S34. Therefore, unnecessary notification to the store clerk may be avoided while the customer is caused to wait in front of the POS device 100 until the upper limit value of the typically-expected time elapses. In addition, when the customer is caused to wait for more than the upper limit value of the typically-expected time, it is probable that an abnormal situation that is to be responded to by a further store clerk occurs, so that a potential abnormal situation may be quickly responded to when the further store clerk is also notified of the result of the approach detection of the customer.

As a modification of the flow of the processing illustrated in FIG. 17, in the processing executed when “YES” is determined in the processing of S21, the previous detection time stored in the storage unit 14 in the previously-executed processing of S33 may be referred to. For example, in a case in which “YES” is determined in the processing of S21, when the previous detection time is stored in the storage unit 14, the processor 15 may determine whether the specific time period already elapses since the previous detection time. For example, the threshold value (specific time period) used for the determination processing of an elapsed time since the previous detection time, which is executed when “YES” is determined in the processing of S21, may be set as appropriate with reference to a time typically assumed as a desired time until the store clerk changes the POS device 100 to the first position and leaves the POS device 100 after the previous detection time is stored in the POS device according to the third embodiment 100 in the second position.

When the processor 15 determines that the specific time period already elapses after the previous detection time, the processor 15 may execute the processing of S22 and the subsequent steps. In addition, when the processor 15 determines that the specific time period does not elapse after the previous detection time, the processor 15 may end the processing according to the third embodiment illustrated in FIG. 17. As a result, when a customer who desires checkout approaches the POS device 100 at the very moment when the store clerk changes the POS device 100 to the first position and leaves the POS device 100, it is assumed that the store clerk recognizes the presence of the customer, so that, even in the first position, unnecessary notification may be avoided so that notification is invalidated until the specific time elapses. Even in a case in which the processing ends, when the specific execution cycle arrives, the processor 15 may execute the processing of S21 and the subsequent steps again.

### Fourth Embodiment

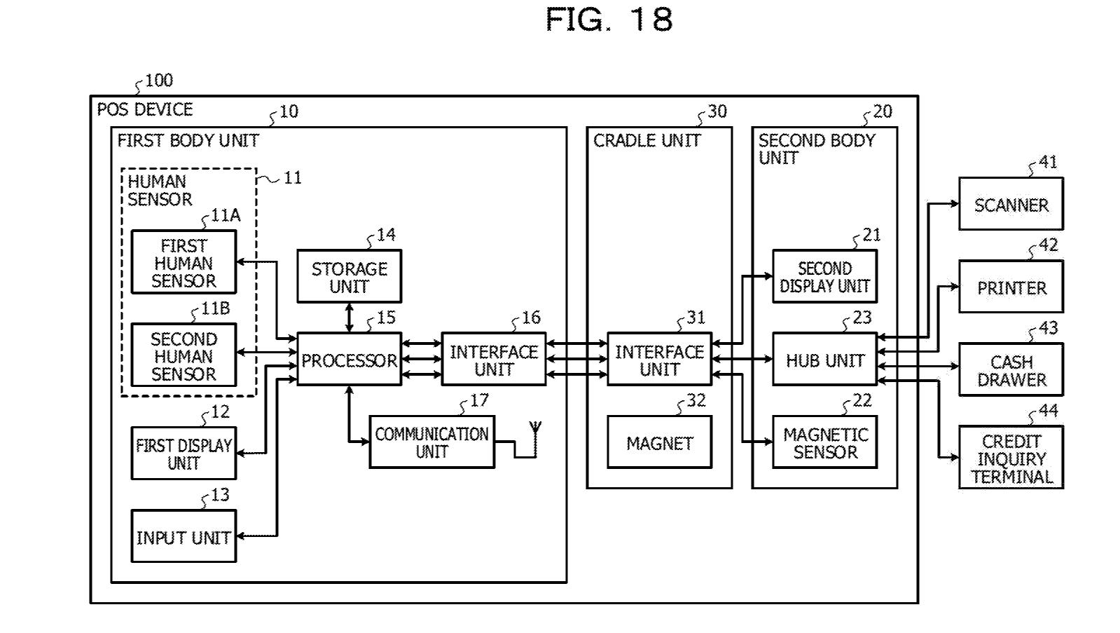

A POS device according to a fourth embodiment 100 is described below. FIG. 18 is a diagram illustrating an example of a configuration of the POS device 100 according to the fourth embodiment. A store clerk terminal 200 may use a configuration similar to that of the first embodiment, so that the description is omitted herein. The POS device 100 illustrated in FIG. 18 is different from the POS device 100 according to the first embodiment illustrated in FIG. 8 in that a human sensor 11 included in a first body unit 10 includes a first human sensor 11A and a second human sensor 11B.

The human sensor 11 illustrated in FIG. 18 is configured to include the first human sensor 11A and the second human sensor 11B. The first human sensor 11A is configured to detect approach of a human body in a detection range including a first direction. The first human sensor 11A is an example of a first detection unit. The second human sensor 11B is configured to detect approach of a human body in a detection range including a second direction. The second human sensor 11B is an example of a second detection unit. In the fourth embodiment, the human sensor 11 operates to activate the first human sensor 11A in the first position and activate the second human sensor 11B in the second position, under the control of a processor 15. The other configurations are similar to those of the first embodiment, so that the description is omitted herein.

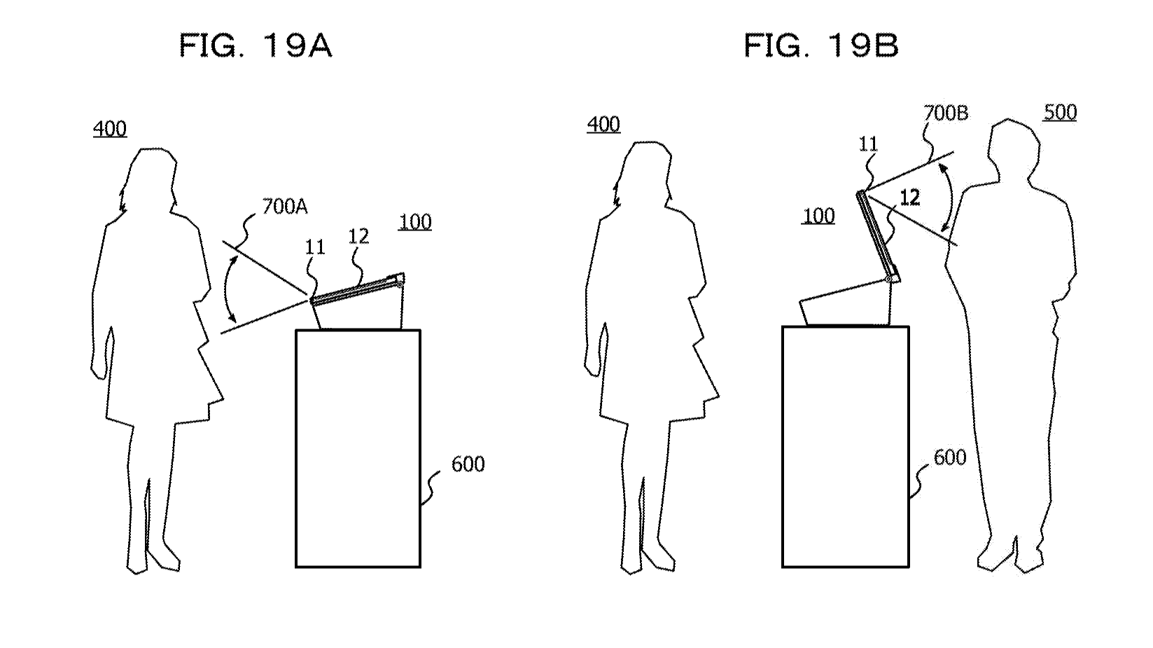

An example of a positional relationship between the POS device according to the fourth embodiment, a customer, and a store clerk is described below with reference to FIGS. 19A and 19B. In FIG. 19A, the first position of the POS device 100 from the side aspect is illustrated. The POS device 100 is mounted on a stand 600, and the display surface of a first display unit 12 faces a customer 400 located on the left side of the stand 600 (first direction). In addition, the human sensor 11 of the POS device 100 may detect the customer 400 in a detection range 700A including the first direction. That is, the human sensor 11 in the first position is configured to detect a human body in the detection range 700A including the first direction by activating the first human sensor 11A under the control of the processor 15. In FIG. 19A, the solid line indicating the detection range 700A illustrates an example of the width of the detection range, and it is not intended that the limitation of a distance in which a human body is allowed to be detected by the human sensor 11 is indicated. A similar condition is applied to the other figures.

In FIG. 19B, the second position of the POS device 100 from the side aspect is illustrated. The POS device 100 is mounted on the stand 600, and the display surface of the first display unit 12 faces a store clerk 500 located on the right side of the stand 600 (second direction). The first display unit 12 is a configuration element of the first body unit 10, and is an example of a movable part. In addition, the human sensor 11 of the POS device 100 may detect the store clerk 500 in a detection range 700B including the second direction. That is, the human sensor 11 in the second position is configured to detect a human body in the detection range 700B including the second direction by activating the second human sensor 11B under the control of the processor 15. Each of the movable part in the first position illustrated in FIG. 19A and the movable part in the second position illustrated in FIG. 19B has a rotation angle of approximately 90 degrees around the hinge unit.

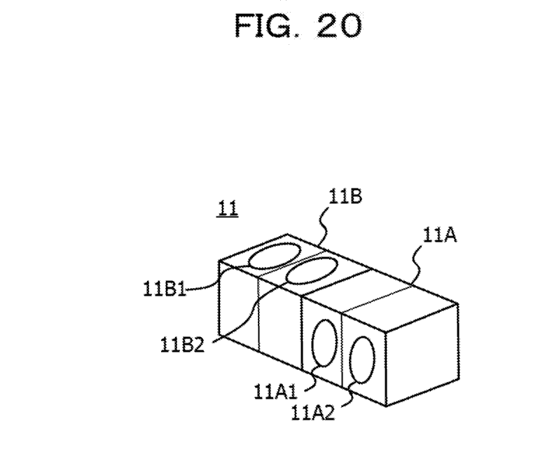

FIG. 20 is a perspective view illustrating an example of the appearance of the human sensor 11 according to the fourth embodiment. In FIG. 20, the human sensor 11 obtained by combining the first human sensor 11A and the second human sensor 11B is illustrated. The human sensors 11A and 11B respectively include light emitting elements 11A1 and 11B1 and light receiving elements 11A2 and 1162. Each of the light emitting elements 11A1 and 1161 is, for example, an infrared LED. Each of the light receiving elements 11A2 and 1162 may be, for example, a PSD.

In the example illustrated in FIG. 20, the detection range of the first human sensor 11A and the detection range of the second human sensor 11B are configured to be substantially orthogonal to each other. As a result, in the first position, light radiated from the light emitting element 11A1 of the first human sensor 11A is projected to the detection range including the first direction through a light emitting part lens and is reflected off the human body in the detection range including the first direction, and the reflected light may enter the light receiving element 11A2 of the first human sensor 11A through a light receiving part lens. In addition, in the second position, light radiated from the light emitting element 11B1 of the second human sensor 11B is projected to the detection range including the second direction through a light emitting part lens and is reflected off the human body in the detection range including the second direction, and the reflected light may enter the light receiving element 1162 of the second human sensor 11B through a light receiving part lens. As illustrated in FIG. 19, the movable part has a rotation angle of approximately 90 degrees between the first position and the second position. In the human sensors 11 according to the fourth embodiment, the detection ranges are shifted by 90 degrees between the first motion sensor 11A and the second motion sensor 11B, so that the detection ranges may be different by approximately 180 degrees between the first position and the second position when the rotation angle of the movable part is considered.

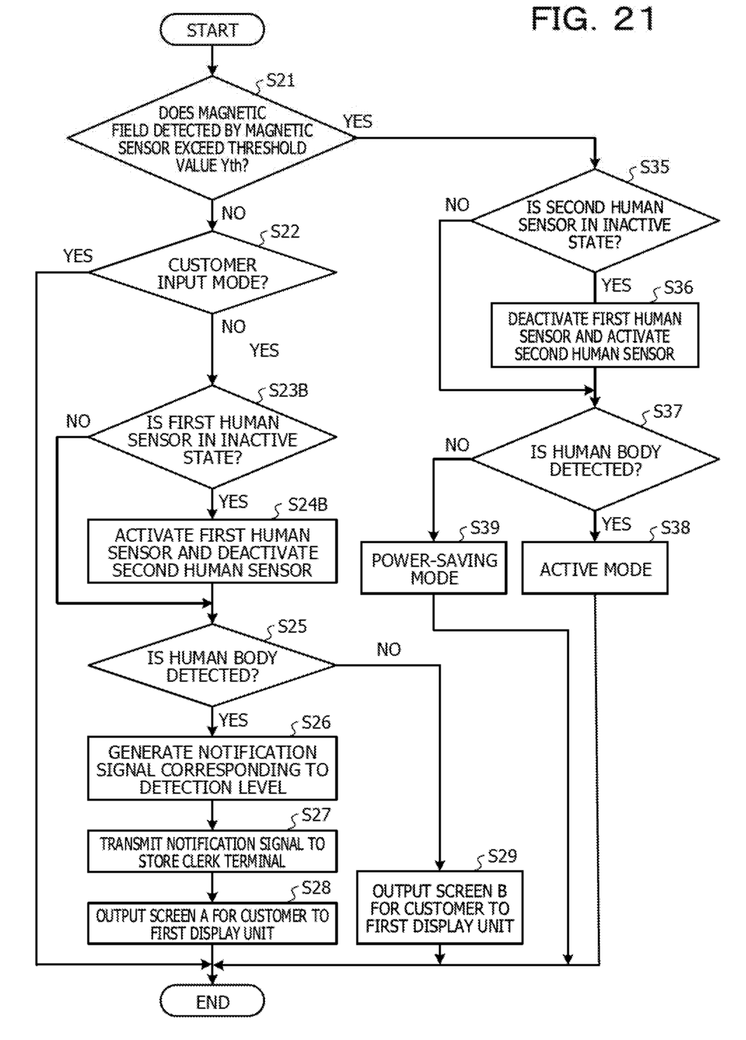

FIG. 21 is a flowchart illustrating an example of a flow of the processing executed by the processor 15 of the POS device 100 according to the fourth embodiment. The flow of the processing illustrated in FIG. 21 is different from the flow of the processing according to the first embodiment illustrated in FIG. 9 in that the human sensor 11 according to the fourth embodiment has a configuration including the first human sensor 11A and the second human sensor 11B, and control targets of the respective human sensors are specified in steps S23B and S24B.

In addition, the processing according to the fourth embodiment illustrated in FIG. 21 is different from the flow of the processing according to the first embodiment illustrated in FIG. 9 in that control is performed so that human body detection is performed using the second human sensor 11B, and the operation state of the POS device is caused to be in a power-saving mode or an active mode depending on a detection result when “NO” is determined in the processing of S21 (that is, when the POS device 100 is in the second position). The other pieces of processing are similar to those of the flow of the processing according to the first embodiment illustrated in FIG. 9, so that the description is omitted herein.

First, in a case in which “YES” is determined in the processing of S21 (that is, when the POS device 100 is in the first position), when the operation state of the POS device 100 is not in the customer input mode (NO in processing of S22), the processor 15 determines whether the first human sensor 11A is in the inactive state (S23B). For example, the processor 15 may determine that the first human sensor 11A is in the inactive state when the processor 15 determines that the value of a register used for control of power supply to the first human sensor 11A is a value indicating that power supply to the first human sensor 11A is not being performed, with reference to the value of the register. The value of the register used for control of the power supply may be, for example, a value indicating whether a clock signal desired for an operation of the first human sensor 11A is supplied to the first human sensor 11A.

When the processor 15 determines that the first human sensor 11A is in the inactive state (YES in S23B), the processor 15 activates the first human sensor 11A and deactivates the second human sensor 11B (S24B). For example, the processor 15 may instruct a power source control circuit that controls power supply to the first human sensor 11A in accordance with the value of the register used for the control of power supply to the first human sensor 11A to start power supply to the first human sensor 11A by rewriting the value of the register to a value indicating that the first human sensor 11A is in the active state. The processor 15 may cause the first human sensor 11A to be in the active state by supplying a clock signal desired for the operation of the first human sensor 11A to the first human sensor 11A. In addition, the processor 15 may instruct a power source control circuit that controls power supply to the second human sensor 11B in accordance with the value of a register used for control of power supply to the second human sensor 11B to block power supply to the second human sensor 11B by rewriting the value of the register to a value indicating the state in which power supply is blocked (inactive state). The pieces of processing of the power source control circuits that respectively control power supply to the first human sensor 11A and the second human sensor 11B in accordance with the values of the registers may be executed by the processor 15. For example, the processor 15 may cause the second human sensor 11B to be in the inactive state by blocking supply of a clock signal desired for the operation of the second human sensor 11B.

The processor 15 determines whether a human body is detected in the detection range including the first direction using a detection signal from the first human sensor 11A, in the state in which the first human sensor 11A is activated (after execution of S24B or NO in S23B) (S25). The processing of S25 and the subsequent steps is similar to that of the processing according to the first embodiment illustrated in FIG. 9, so that the description is omitted herein.

The processing in the case of the second position is described below. When “NO” is determined in the processing of S21 illustrated in FIG. 21 (that is, when the POS device 100 is in the second position), the processor 15 determines whether the second human sensor 11B is in the inactive state (S35). For example, when the processor 15 determines that the value of the register used for control of power supply to the second human sensor 11B is a value indicating that power supply to the second human sensor 11B is not being performed, with reference to the value of the register, the processor 15 may determine that the second human sensor 11B is in the inactive state. The value of the register used for control of the power supply may be, for example, a value indicating whether a clock signal desired for the operation of the second human sensor 11B is supplied to the second human sensor 11B.

When the processor 15 determines that the second human sensor 11B is in the inactive state (YES in S35), the processor 15 activates the second human sensor 11B and deactivates the first human sensor 11A (S36). For example, the processor 15 may instruct the power source control circuit that controls power supply to the second human sensor 11B in accordance with the value of the register used for control of power supply to the second human sensor 11B to start power supply to the second human sensor 11B by rewriting the value of the register to a value indicating that the second human sensor 11B is in the active state. The processor 15 may cause the second human sensor 11B to be in the active state by supplying a clock signal desired for the operation of the second human sensor 11B to the second human sensor 11B.

In addition, the processor 15 may instruct the power source control circuit that controls power supply to the first human sensor 11A in accordance with the value of the register used for control of power supply to the first human sensor 11A to block power supply to the first human sensor 11A by rewriting the value of the register to a value indicating a state in which power supply is blocked (inactive state). The pieces of processing of the power source control circuits that respectively control power supply to the first human sensor 11A and the second human sensor 11B in accordance with the values of the registers may be executed by the processor 15. For example, the processor 15 may cause the first human sensor 11A to be in the inactive state by blocking supply of a clock signal desired for the operation of the first human sensor 11A.

In the state in which the second human sensor 11B is activated (after execution of S36 or NO in S35), the processor 15 determines whether a human body is detected in the detection range including the second direction using a detection signal from the second human sensor 11B (S37). For example, the processor 15 may determine that a human body is not detected when the processor 15 receives one or more detection signals supplied from the second human sensor 11B, and the detection signals which indicate a value less than the specific threshold value Xth continuously received the specific number of times, in a time interval shorter than the execution cycle of the processing illustrated in FIG. 21. When the sequentiality of detection signals each of which is less than the threshold value is determined, it may be avoided that the mode is changed to the power-saving mode by mistake despite the operation of the POS device 100 by the store clerk.

In addition, in the processing of S37, the processor 15 determines that a human body (store clerk) is detected in the detection range including the second direction (YES in S37), the processor 15 changes or maintains the operation state of the POS device 100 to or at the active mode (S38). For example, the POS device 100 may execute processing by a further program such as checkout processing in the active mode. In addition, the POS device 100 may perform control in the active mode so as to activate the first display unit 12 and display a screen for the store clerk on the first display unit 12.

In addition, the above-described processing of S37, when a human body is not detected in the detection range including the second direction (NO in S37), the processor 15 changes or maintains the operation state of the POS device 100 to or at the power-saving mode (S39). For example, in the power-saving mode, the processor 15 of the POS device 100 may deactivate the first display unit 12 and darken the screen display of the first display unit 12 by turning off the backlight of the display surface. In addition, in the power-saving mode, the processor 15 of the POS device 100 may perform control so as to reduce the power consumption of peripheral equipment coupled to the hub unit 23.

In addition, the processor 15 of the POS device 100 may transmit an instruction that causes the state to transition to the lock state, to peripheral equipment such as the cash drawer 43 though the interface unit 16, the interface unit 31, and the hub unit 23 before starting the power saving state. For example, the cash drawer 43 may put a shelf (cash container) that stores cash back in the device and take measures to avoid withdrawal of the cash. As described aboe, the processing according to the fourth embodiment illustrated in FIG. 21 includes such a flow.

The configuration elements of the units illustrated in the above-described first to fourth embodiments may not be physically configured as illustrated in the diagrams. That is, specific configurations of distribution and integration of the units are not limited to those illustrated in the drawings, and all or a part of the units may be configured to be distributed or integrated functionally or physically in arbitrary units depending on various loads, usage conditions, and the like. For example, the processor 15 of the POS device 100 may be provided in the second body unit 20. Alternatively, the processor is provided in each of the first body unit 10 and the second body unit 20, and the above-described processing according to the first to fourth embodiments may be executed so that the plurality of processors are caused to be cooperated with each other.

In addition, all or a part of the various processing functions executed in the devices may be executed on a CPU (or a microcomputer such as an MPU) or a micro controller unit (MCU)). In addition, all or a part of the various processing functions may be executed on a program analyzed and executed by a CPU (or a microcomputer such as an MPU or an MCU) or on hardware by wired logic.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A point of sales (POS) device comprising:
a movable part configured to be switchable between a first position in which the movable part faces in a first direction and a second position in which the movable part faces in a second direction;
a sensor configured to detect an object in a detection range including the first direction; and
a control circuit configured to determine whether the movable part is in the first position and if the movable part is in the first position, control notification to a store clerk in accordance with a detection signal from the sensor.

2. The POS device according to claim 1, wherein
the movable part is configured to be switchable between the first position and the second position, the first position being a position in which the movable part faces in the first direction, the second position being a position in which the movable part faces in the second direction and processing associated with operation of the store clerk located at a position in the second direction is executed in the POS device.

3. The POS device according to claim 1, wherein
the first position is a configuration in which processing associated with an operation of a customer located at a position in the first direction is executed in the POS device.

4. The POS device according to claim 1, further comprising
a display device in which a display surface is provided on the movable part, wherein
the display surface of the display device faces in the first direction when the movable part is in the first position, and the display surface of the display device faces in the second direction when the movable part is in the second position, and
the control circuit executes, if the display surface of the display device faces in the first direction, processing that notifies the store clerk of presence of a customer detected by the sensor.

5. The POS device according to claim 1, wherein
the sensor is provided in the movable part so as to face in the first direction when the movable part is in the first position and face in a direction different from the first direction when the movable part is in the second position, and
the control circuit executes, if the movable part is in the first position, processing that notifies the store clerk of presence of a customer detected by the sensor provided in the movable part.

6. The POS device according to claim 1, further comprising
a second sensor that detects presence of the store clerk near the POS device, wherein
the control circuit notifies the store clerk of presence of a customer detected by the sensor during the movable part is in the second position, if the second sensor is shifted from a first state to a second state, the first state being a state in which the second sensor detects the presence of the store clerk, the second state being a state in which the second sensor does not detect the presence of the store clerk.

7. The POS device according to claim 1, wherein
the sensor includes
a first detection circuit configured to detect an object in a first detection range including the first direction,
a second detection circuit configured to detect an object in a second detection range including the second direction, and
if the movable part is in the first position, the control circuit is configured to notify the store clerk of presence of a customer detected by the first detection circuit, and
if the movable part is in the second position, the control circuit is configured to set an operation state at a power-saving mode during an object is not detected by the second detection circuit.

8. A control method executed by a POS device, comprising:
determining whether a movable part in a POS device is in a first position, the movable part being switchable between the first position and a second position, the first position being a position in which the movable part faces in a first direction, the second position being a position in which the movable part faces in a second direction; and
if the movable part is in the first position, controlling notification to a store clerk in accordance with a detection signal from the sensor.

9. A non-transitory computer-readable storage medium for storing a program that causes a computer to execute a process, the process comprising:
determining whether a movable part in a POS device is in a first position, the movable part being switchable between the first position and a second position, the first position being a position in which the movable part faces in a first direction, the second position being a position in which the movable part faces in a second direction; and
if the movable part is in the first position, controlling notification to a store clerk in accordance with a detection signal from the sensor.
